(19) United States
(12) Patent Application Publication
(10) Pub. No.: US 2026/0312949 A1
(43) Pub. Date: Oct. 8, 2026

(54) Steganographic Attachment Preview and Traceability System

(71) Applicant: Bank of America Corporation, Charlotte, NC (US)

(72) Inventors: Adam King, Fort Mill, SC (US); Jeremy James Arel, Fort Mill, SC (US); Peter Nein, Waxhaw, NC (US); Brittney K. Spencer, Fort Mill, SC (US); Erica Finigan, Charlotte, NC (US); Tori Mitcheson, Fort Mill, SC (US); Naga Vamsi Krishna Akkapeddi, Charlotte, NC (US); Sanjay Lohar, Mint Hill, NC (US); Matthew Bryant, Mt. Holly, NC (US); Julie Stanley, Indian Land, SC (US); James Siekman, Charlotte, NC (US)

(21) Appl. No.: 19/172,904

(22) Filed: Apr. 8, 2025

(51) Int. Cl. H04L 9/40; G06F 21/16

(52) U.S. Cl. CPC H04L 63/083; G06F 21/16; H04L 63/166

(57) ABSTRACT

A system and method secure electronic attachments in a communication network by receiving an attachment, rendering it in a sandbox to generate a preview image, and embedding a steganographic watermark with a unique identifier and dynamic code. The preview image is normalized and transmitted over a secure channel. Recipients request the full attachment via multi-factor authentication, verifying credentials and the dynamic code. The watermark is refreshed periodically, and the preview image is monitored to detect movement outside a designated domain, triggering blocking or deletion. Metadata images are generated for non-visual files, and rendering uses file-type-specific headless applications. Tracking logs movement, and enforcement integrates with security systems, ensuring traceability and control while preventing unauthorized access and execution of malicious content.

### TECHNICAL FIELD

The inventions disclosed herein pertain to techniques for ensuring the security and integrity of digital data transmission, particularly through the processing and management of electronic communications and their associated attachments. The technology involves converting digital files into sanitized, viewable representations using image processing and embedding hidden, traceable identifiers within those representations through steganographic methods. These methods enable secure data exchange by preventing unauthorized access to executable content while maintaining the ability to monitor and control the distribution of sensitive information across networks. Additionally, the inventions encompass systems for authenticating users and dynamically updating security features, integrating with network security protocols to enforce access restrictions and track data movement in real-time, aligning with advancements in digital communication security and data protection technologies.

### DESCRIPTION OF THE RELATED ART

Electronic communication systems, such as email and messaging platforms, serve as vital conduits for exchanging information across various sectors, including those requiring high security like financial institutions and private communications for prominent individuals. These systems often transmit attachments that carry essential data, ranging from documents to multimedia files. However, a significant challenge arises from the potential presence of malicious content embedded within these attachments. Malware, viruses, and other harmful entities can infiltrate networks through these files, attacking vulnerabilities and compromising sensitive information. The ease with which such threats propagate stems from the direct transmission of full binary files, which recipients may open without sufficient scrutiny, exposing systems to substantial risks.

The susceptibility of traditional communication systems to phishing attacks exacerbates this issue. Phishing schemes frequently rely on deceptive emails that lure users into interacting with malicious attachments or embedded links. These attacks succeed because users, either through haste or lack of awareness, engage with content that appears legitimate. Once activated, the malicious payload can execute code, extract data, or establish unauthorized access points within a secure environment. This problem persists across industries, where the stakes of data breaches are high, leading to financial losses, reputational damage, and operational disruptions. The inability to preemptively neutralize such threats before they reach the recipient remains a persistent obstacle.

Another layer of complexity emerges from the lack of control over attachments once they leave a secure domain. In conventional systems, files sent via email or messaging platforms become detached from oversight mechanisms upon delivery. Recipients can forward, share, or store these files without restriction, creating opportunities for unintended distribution. This loss of governance poses a severe challenge in environments where confidentiality and data integrity are paramount. Sensitive information, such as proprietary records or personal details, can proliferate beyond intended boundaries, falling into unauthorized hands without any means of detection or retraction.

The potential for data exfiltration through covert methods adds further difficulty to securing electronic communications. Techniques like steganography, which involve hiding data within seemingly innocuous files, enable malicious actors to bypass traditional detection tools. Such hidden payloads can reside in images, audio, or other file types, evading scrutiny while facilitating the unauthorized transfer of information. This subtlety complicates efforts to safeguard systems, as standard antivirus or firewall solutions often fail to identify these concealed threats. The absence of mechanisms to detect and neutralize such tactics leaves organizations vulnerable to sophisticated breaches.

Human error compounds these challenges within communication systems. Users may inadvertently click on harmful links or open compromised attachments due to fatigue, distraction, or insufficient training. Even in highly secure contexts, the unpredictability of human interaction with digital content undermines protective measures. This issue persists despite extensive efforts to educate users and implement warning systems, as the volume and variety of communications make it impractical to eliminate all instances of accidental engagement. The resulting breaches highlight a gap in existing approaches, where the focus remains on post-incident response rather than preemptive mitigation.

The normalization of file appearance across different systems presents an additional hurdle. Attachments rendered in varying formats or color profiles can obscure subtle indicators of tampering or hidden content. Without a standardized method to process and inspect these files, security teams struggle to maintain consistency in threat detection. This lack of uniformity allows malicious elements to slip through undetected, particularly when files are viewed or shared across disparate platforms. The challenge intensifies in large organizations where multiple endpoints and software configurations must be accounted for, amplifying the potential for oversight.

Tracking the movement of sensitive attachments poses yet another problem in traditional setups. Once a file is transmitted, its subsequent journey-whether forwarded internally or leaked externally-remains opaque to the originating system. This opacity hinders efforts to audit data flows and identify points of compromise. In scenarios where a breach occurs, reconstructing the path of a compromised file becomes a time-consuming and often inconclusive process. The absence of a reliable tracing mechanism limits accountability and delays response efforts, allowing damage to escalate before containment measures can be enacted.

The integration of security protocols with communication systems often falls short of addressing these issues comprehensively. While encryption and authentication provide layers of protection, they do not inherently prevent the initial transmission of malicious content or track its dissemination. Firewalls and intrusion detection systems operate reactively, identifying threats only after they manifest within the network. This reactive stance leaves a window of vulnerability during which harm can occur unchecked. The disconnect between preventive and monitoring capabilities underscores a broader deficiency in safeguarding digital exchanges.

The persistence of these problems reflects a deeper systemic limitation in conventional approaches to attachment security. Solutions like sandboxing or file scanning offer partial relief but fail to address the full spectrum of risks, from accidental activation to unauthorized distribution. The reliance on end-user vigilance or isolated tools proves inadequate in high-stakes environments where zero tolerance for breaches is necessary. As communication volumes grow and threats evolve, the gap between existing defenses and emerging challenges widens, necessitating a more proactive and integrated strategy.

For years, organizations have sought a way to reconcile the need for seamless data exchange with the imperative of absolute security, yet no comprehensive solution has emerged. The recurring incidents of malware infections, data leaks, and phishing successes demonstrate a long-felt and unmet need for an approach that prevents threats at the point of transmission, maintains control over sensitive content, and provides visibility into its lifecycle. This need has grown more pressing with the increasing sophistication of attacks and the reliance on digital communication, leaving a void that current technologies have failed to fill despite extensive research and investment.

### SUMMARY OF THE INVENTION

The invention involves a system designed to enhance the security of electronic communication by transforming incoming attachments into secure preview images. This process begins with the receipt of an attachment, which could be a document, multimedia file, or other digital content transmitted via email or messaging platforms. Rather than sending the original file directly to the recipient, the system processes it within a controlled, isolated environment known as a sandbox. In this environment, the attachment is opened and rendered into a visual representation, such as a screenshot, capturing its content in a standardized image format. This transformation ensures that the executable elements of the original file, which might harbor malicious code, are not transmitted initially, thereby reducing the risk of immediate harm to the recipient's system.

Once the preview image is generated, the system applies a normalization process to standardize its appearance. This step utilizes image processing techniques to adjust color profiles and other visual attributes, ensuring consistency across different viewing platforms. For files that lack a visual component, such as raw data or executable binaries, the system creates a default representation that includes key metadata, providing recipients with a meaningful glimpse of the content without exposing the underlying file. This normalization not only aids in uniform presentation but also serves as a foundation for subsequent security enhancements, preparing the image for the embedding of protective features.

A distinctive aspect of the invention is the use of steganographic techniques to embed unique watermarks into these preview images. These watermarks, referred to as “tattoos,” consist of specific character sequences and dynamic codes that act as digital fingerprints. The embedding process employs methods such as Least Significant Bit insertion, where subtle changes to pixel values conceal the watermark without altering the image's visible quality. Alternatively, frequency-domain techniques, like Discrete Cosine Transform or Discrete Wavelet Transform, modify the image's frequency coefficients to integrate the hidden data, offering resilience against compression or other manipulations. These watermarks enable the system to track the image's distribution and verify its authenticity.

The dynamic nature of the watermarks sets this system apart from static security measures. The embedded codes are refreshed periodically, such as every 24 hours, through a secure update mechanism. A trusted server delivers these updates over a connection secured by HTTPS and Transport Layer Security, ensuring the integrity of the process. Each update is digitally signed using cryptographic algorithms like RSA or Elliptic Curve Digital Signature Algorithm, allowing the system to verify the signature and confirm the validity of the new code. This periodic refresh ensures that the watermarks remain current, enhancing the system's ability to distinguish legitimate instances of the image from outdated or tampered versions.

The delivery of these preview images to recipients occurs over a secure channel, utilizing HTTPS and Transport Layer Security to protect the data in transit. Unlike traditional systems that transmit full attachments, this approach sends only the sanitized image, stripping away executable content that could pose a threat. Recipients receive this preview as the initial point of interaction, allowing them to assess the content visually without engaging with potentially harmful elements. This method shifts the paradigm of attachment handling, prioritizing safety while preserving the utility of communication.

For recipients requiring access to the full attachment, the system incorporates an on-demand release process. This process begins with a request initiated by the recipient, typically through a user interface integrated into the communication platform. The request triggers an authentication workflow managed by an identity and access management service, such as Auth0, Okta, or Microsoft Entra ID. The system verifies the recipient's credentials, often employing multi-factor authentication to ensure security. It then checks the recipient's role and privileges against predefined policies stored in a secure directory, using role-based access control to determine eligibility.

Upon successful authentication, the system validates a secure token or dynamic code linked to the specific attachment request. This step confirms that the request originates from an authorized source within the established security hierarchy. Only after these checks are completed does the system release the full attachment, delivering it securely to the recipient. This layered authentication process ensures that access to the original file remains tightly controlled, limiting exposure to only those with verified need and authority.

The invention also provides robust traceability features through the monitoring of the embedded watermarks. As the preview image circulates within or beyond the network, the system logs each instance of its appearance, capturing timestamps and transmission metadata in an audit trail. Security tools, such as Security Information and Event Management systems like Splunk or IBM QRadar, and Data Loss Prevention systems, facilitate this monitoring. These tools analyze the watermark data to track the image's path, offering visibility into its distribution and usage across endpoints. If the preview image attempts to leave the designated secure domain, the system activates automated controls to intervene. Data Loss Prevention systems, such as those from Symantec or Microsoft Endpoint DLP, can block further transmission based on predefined rules. Alternatively, endpoint management solutions like Microsoft Intune enable the remote deletion of the image from unauthorized devices. These controls leverage the watermark as a trigger, ensuring rapid response to potential breaches and maintaining the integrity of the secure environment.

Integration with existing network security protocols enhances the system's effectiveness. Secure APIs, built on platforms like Apigee or Mulesoft and adhering to RESTful standards, connect the system to internal security frameworks. Protocols such as SAML, OAuth 2.0, and Transport Layer Security govern these interactions, enforcing restrictions on how watermarked images can be shared or forwarded. The APIs incorporate JSON Web Tokens for session management and role-based access control, ensuring that only authorized actions are permitted within the network.

Real-time monitoring complements these controls, with Security Information and Event Management systems tracking the movement of watermarked images continuously. Anomalous behavior, such as attempts to exfiltrate the image, triggers alerts that prompt immediate investigation or automated responses. This proactive oversight contrasts with reactive security measures, providing a dynamic shield against unauthorized distribution and enhancing overall data protection.

The system's use of sandboxing for attachment rendering adds an additional layer of security. By isolating the file in a controlled environment, the invention prevents any malicious code from executing during the preview generation process. Tools like LibreOffice in headless mode or Puppeteer, a headless browser, handle the rendering, capturing the screenshot without exposing the host system. This isolation ensures that the transformation process remains safe, even for files with unknown or suspicious content.

For non-visual files, the generation of a default visual representation offers a practical solution. The system extracts key metadata-such as file type, size, or origin- and presents it in an image format alongside a generic placeholder. This approach ensures that all attachments, regardless of their nature, can be previewed securely, maintaining consistency across the communication platform. Recipients gain sufficient context to decide whether to request the full file, streamlining the workflow.

The watermarking process supports both security and forensic capabilities. The embedded character sequences and dynamic codes serve as unique identifiers that can be extracted later for analysis. If an image is found outside the secure domain, security teams can decode the watermark to trace its origin, last authorized recipient, and transmission history. This traceability aids in breach investigations, offering a clear audit trail that traditional systems lack.

The invention's adaptability to various file types broadens its applicability. Whether processing PDFs, images, or executables, the system applies the same transformation and watermarking principles, ensuring uniform protection. The use of open-source tools like OpenCV for image processing and established cryptographic standards like RSA or ECDSA enhances its reliability and scalability, making it suitable for large organizations with diverse communication needs.

The periodic refresh of dynamic codes introduces a time-sensitive element to the security framework. By updating the watermarks regularly, the system ensures that older versions of the image lose validity, reducing the window for misuse. The secure update process, backed by digital signatures, prevents tampering, maintaining the trustworthiness of the watermarking mechanism over time.

The invention leverages existing security infrastructure while introducing novel enhancements. By interfacing with Data Loss Prevention and endpoint management systems, it amplifies their effectiveness through the addition of steganographic tracking. The seamless integration with authentication services and network protocols ensures that it fits within established workflows, minimizing disruption while maximizing protection.

The combination of preview generation, steganographic watermarking, and automated controls creates a multi-faceted defense against threats in electronic communication. Each component reinforces the others, forming a cohesive system that prioritizes safety, control, and visibility. The result is a comprehensive approach that addresses multiple facets of attachment security in a unified manner.

The technical implementation of the system relies on a blend of established and innovative techniques. Sandboxing, image processing, steganography, and cryptographic signing converge to deliver a robust solution. The flexibility to adjust parameters—such as the frequency of watermark updates or the specifics of authentication-allows customization to suit different organizational requirements, enhancing its practical utility.

In light of the preceding discussion, the following identifies various sample embodiments of the present disclosure to establish a basic understanding of its various components. This summary is not exhaustive, nor does it limit the illustrative embodiments of the inventions described in this document. It is not intended to identify the most essential features or steps of the disclosure, nor to define its scope. Instead, as would be recognized by someone skilled in the field, it seeks to introduce certain concepts of the disclosure in a clear and simple way, acting as a preface to the more detailed explanation that follows. Throughout this application, the specification offers thorough written descriptions of the inventions, including exemplary, non-exhaustive, and non-limiting methods and processes for making and using the inventions. These descriptions are expressed in complete, clear, concise, and precise terms, allowing those skilled in the art to implement and utilize various embodiments of the inventions without undue experimentation.

In some arrangements, a method secures electronic attachments in a communication system by utilizing a processing module to receive an electronic attachment transmitted through the communication system, where the electronic attachment includes digital content. The processing module renders the electronic attachment within a sandbox environment to generate a preview image, and the sandbox environment is configured to isolate the electronic attachment from the communication system and prevent execution of the digital content. A watermarking module embeds a steganographic watermark into the preview image, where the steganographic watermark includes a unique identifier and a dynamic code configured to be periodically updated.

In some arrangements, a delivery module transmits the preview image with the embedded steganographic watermark to a recipient over a secure channel, where the secure channel employs a transport layer security protocol. An authentication module authenticates a request from the recipient for the electronic attachment, where the authentication module verifies the recipient's credentials and the dynamic code within the steganographic watermark. The delivery module releases the electronic attachment to the recipient over the secure channel upon successful authentication. A tracking module monitors the preview image within the communication system using the steganographic watermark to detect movement of the preview image outside a designated secure domain.

In some arrangements, the method includes configuring the sandbox environment as a virtual machine with restricted network access and a read-only filesystem.

In some arrangements, the processing module normalizes the preview image to standardize color and resolution prior to embedding the steganographic watermark. The processing module generates the preview image with metadata text when the electronic attachment lacks visual content.

In some arrangements, the watermarking module embeds the steganographic watermark using a least significant bit insertion technique modifying pixel values of the preview image.

In some arrangements, the watermarking module refreshes the dynamic code within the steganographic watermark at a predetermined interval. The delivery module updates the preview image with the refreshed dynamic code across the communication system.

In some arrangements, the authentication module employs a multi-factor authentication process to verify the recipient's credentials, including a secure token associated with the request.

In some arrangements, the tracking module logs each detected instance of the preview image within the communication system using the unique identifier. The tracking module associates transmission metadata with each logged instance.

In some arrangements, a control module enforces a restriction on the preview image by blocking transmission outside the designated secure domain upon detection by the tracking module. The control module initiates a remote deletion of the preview image from an endpoint outside the designated secure domain when blocking is unsuccessful.

In some arrangements, the processing module renders the electronic attachment using a headless application selected based on a file type of the electronic attachment.

In some arrangements, the watermarking module requests the dynamic code from a secure server over a connection secured by a transport layer security protocol. The watermarking module verifies a digital signature of the dynamic code using an asymmetric encryption algorithm.

In some arrangements, a method secures electronic attachments in a communication system by utilizing a processing module to receive an electronic attachment transmitted through the communication system, where the electronic attachment includes digital content potentially containing executable elements. The processing module renders the electronic attachment within a sandbox environment to generate a preview image, where the sandbox environment is configured as a virtual machine with restricted network access and a read-only filesystem to isolate the electronic attachment from the communication system and prevent execution of the digital content.

In some arrangements, the processing module normalizes the preview image to standardize color and resolution, and generates the preview image with metadata text when the electronic attachment lacks visual content. A watermarking module embeds a steganographic watermark into the preview image using a least significant bit insertion technique modifying pixel values of the preview image, where the steganographic watermark includes a unique identifier and a dynamic code configured to be periodically updated. The watermarking module requests the dynamic code from a secure server over a connection secured by a transport layer security protocol, and verifies a digital signature of the dynamic code using an asymmetric encryption algorithm.

In some arrangements, a delivery module transmits the preview image with the embedded steganographic watermark to a recipient over a secure channel, where the secure channel employs the transport layer security protocol. An authentication module authenticates a request from the recipient for the electronic attachment, where the authentication module verifies the recipient's credentials using a multi-factor authentication process including a secure token associated with the request, and confirms the dynamic code within the steganographic watermark. The delivery module releases the electronic attachment to the recipient over the secure channel upon successful authentication.

In some arrangements, a tracking module monitors the preview image within the communication system using the steganographic watermark to detect movement of the preview image outside a designated secure domain. The tracking module logs each detected instance of the preview image within the communication system using the unique identifier, and associates transmission metadata with each logged instance. A control module enforces a restriction on the preview image by blocking transmission outside the designated secure domain upon detection by the tracking module, and initiates a remote deletion of the preview image from an endpoint outside the designated secure domain when blocking is unsuccessful.

In some arrangements, the watermarking module refreshes the dynamic code within the steganographic watermark at a predetermined interval, and the delivery module updates the preview image with the refreshed dynamic code across the communication system. The processing module renders the electronic attachment using a headless application selected based on a file type of the electronic attachment. An interface module integrates the communication system with a security information and event management system to provide real-time alerts upon detection of the preview image outside the designated secure domain. The control module adjusts enforcement actions based on a predefined policy specifying conditions for blocking, deleting, or quarantining the preview image.

In some arrangements, a system secures electronic attachments in a communication network with a processing module configured to receive an electronic attachment transmitted through the communication network, where the electronic attachment includes digital content. The processing module renders the electronic attachment within a sandbox environment to generate a preview image, where the sandbox environment isolates the electronic attachment from the communication network and prevents execution of the digital content.

In some arrangements, a watermarking module embeds a steganographic watermark into the preview image, where the steganographic watermark includes a unique identifier and a dynamic code configured to be periodically updated. A delivery module transmits the preview image with the embedded steganographic watermark to a recipient over a secure channel, where the secure channel employs a transport layer security protocol, and releases the electronic attachment to the recipient over the secure channel upon successful authentication. An authentication module authenticates a request from the recipient for the electronic attachment by verifying the recipient's credentials and the dynamic code within the steganographic watermark. A tracking module monitors the preview image within the communication network using the steganographic watermark to detect movement of the preview image outside a designated secure domain.

In some arrangements, the sandbox environment of the processing module is configured as a virtual machine with restricted network access and a read-only filesystem.

In some arrangements, the processing module is configured to normalize the preview image to standardize color and resolution before the steganographic watermark is embedded, and to generate the preview image with metadata text when the electronic attachment lacks visual content.

In some arrangements, the watermarking module is configured to embed the steganographic watermark using a least significant bit insertion technique modifying pixel values of the preview image.

In some arrangements, the watermarking module is configured to refresh the dynamic code within the steganographic watermark at a predetermined interval, and the delivery module is configured to update the preview image with the refreshed dynamic code across the communication network.

In some arrangements, the authentication module is configured to employ a multi-factor authentication process to verify the recipient's credentials, including validation of a secure token associated with the request.

In some arrangements, the tracking module is configured to log each detected instance of the preview image within the communication network using the unique identifier and to associate transmission metadata with each logged instance.

In some arrangements, a control module is configured to enforce a restriction on the preview image by blocking transmission outside the designated secure domain upon detection by the tracking module, and to initiate a remote deletion of the preview image from an endpoint outside the designated secure domain when blocking is unsuccessful.

In some arrangements, the processing module is configured to render the electronic attachment using a headless application selected based on a file type of the electronic attachment, where the headless application operates within the sandbox environment to produce the preview image. The watermarking module is configured to request the dynamic code from a secure server over a connection secured by the transport layer security protocol, to verify a digital signature of the dynamic code using an asymmetric encryption algorithm, and to adjust an embedding depth of the steganographic watermark based on a security level assigned to the electronic attachment.

In some arrangements, the delivery module is configured to encrypt the preview image prior to transmission using a symmetric encryption key derived from the secure channel, and to maintain a record of each transmission of the preview image and the electronic attachment. The authentication module is configured to integrate with an identity management service to retrieve the recipient's credentials, to cross-reference the recipient's role against a predefined access policy, and to re-authenticate the recipient if the dynamic code has been refreshed since the request was initiated.

In some arrangements, the tracking module is configured to interface with a security information and event management system to log real-time movement data of the preview image, and to generate an audit trail linking the unique identifier to each logged instance. The control module is configured to adjust enforcement actions based on a predefined policy specifying conditions for blocking, deleting, or quarantining the preview image, and to notify an administrator via the security information and event management system when the preview image is detected outside the designated secure domain.

The following description and claims, in conjunction with the drawings-all integral parts of this specification-will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on non-transitory computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 is an exemplary system architecture diagram in accordance with one or more embodiments disclosed herein that illustrates the interconnected components for securing electronic attachments in a communication network. It depicts the flow of data and control between modules responsible for processing, watermarking, delivering, authenticating, tracking, and controlling electronic attachments to ensure security, traceability, and enforcement across the network, incorporating conversion, preview generation, and dynamic watermark updates.

FIG. 2 is an exemplary flow diagram in accordance with one or more embodiments disclosed herein that illustrates the sequential process for securing electronic attachments in a communication network. It outlines the steps from receiving an attachment to generating traceable previews, authenticating recipients, releasing full attachments, and enforcing security controls with real-time monitoring and dynamic updates.

FIG. 3 is an exemplary sequence diagram in accordance with one or more embodiments disclosed herein that illustrates the interactions between actors in a communication network for securing electronic attachments. It details the sequential flow of data and commands across components, from receiving an attachment to delivering a secure preview, authenticating access, enforcing controls, and updating watermarks dynamically.

FIG. 4 is an exemplary class diagram in accordance with one or more embodiments disclosed herein that illustrates the object-oriented structure and relationships of components within a system for securing electronic attachments in a communication network. It details the classes, their attributes, methods, and interconnections that enable the transformation, watermarking, delivery, authentication, tracking, and control of attachments with dynamic security features.

FIG. 5 illustrates a detailed hybrid diagram for a process for managing digital attachments, encompassing data transformation and watermarking, secure preview delivery with recipient validation, and watermark monitoring with security controls. The figure outlines a sequential workflow from receiving incoming attachments to embedding unique watermarks, delivering secure previews, validating recipients, releasing full attachments, and tracking watermarks with automated security measures.

### DETAILED DESCRIPTION

The Steganographic Attachment Preview and Traceability System represents an innovative solution to a pervasive issue in traditional communication platforms, where the direct transmission of full attachments exposes users to significant risks from malware and malicious content. In high-security environments, such as banking institutions or private communications for high net-worth individuals, this vulnerability can lead to phishing attacks or unauthorized data exfiltration, necessitating a more secure approach to attachment handling. The invention mitigates these risks by transforming incoming attachments into preview images that serve as safe, visual proxies, allowing recipients to evaluate content without immediately engaging with potentially harmful binaries. This fundamental shift from sending full files to delivering sanitized previews establishes a protective barrier that aligns with the stringent security demands of sensitive contexts.

Upon receiving an attachment through the communication network, the system employs a processing module that intercepts and directs it to a sandbox environment for secure rendering. This sandbox acts as an isolated space where the attachment is opened and converted into a visual representation, such as a screenshot, using tools like LibreOffice in headless mode for documents and PDFs or Puppeteer for web-based content. For files lacking inherent visual elements, such as executables or data logs, the system generates a standardized image embedded with metadata-like file name, size, and type-ensuring every attachment produces a consistent preview. This rendering process prevents any embedded code from executing, safeguarding the network while preserving the ability to inspect the attachment's intent.

The generated preview image then undergoes a normalization step to ensure uniformity in appearance, addressing potential discrepancies in color or resolution that could affect downstream processes. Using image processing libraries like OpenCV, the system adjusts the image to a fixed resolution, typically 800×600 pixels, and applies color correction techniques to maintain consistency across diverse devices and platforms. This standardized image becomes the foundation for embedding steganographic watermarks, a distinctive feature that enhances security by adding traceable identifiers. These watermarks, referred to as “tattoos,” combine a unique 16-character alphanumeric sequence with a dynamic code that refreshes periodically, typically every 24 hours, to provide a time-sensitive security layer.

The embedding of steganographic watermarks utilizes advanced techniques to conceal data within the preview image, ensuring it remains imperceptible to the human eye while detectable by monitoring systems. Least Significant Bit insertion modifies the least significant bits of pixel values to encode the watermark, offering a subtle yet effective method, while frequency-domain approaches like Discrete Cosine Transform or Discrete Wavelet Transform embed data into frequency coefficients for greater durability against image alterations. The dynamic code, sourced from a secure server over a TLS-secured connection, is digitally signed with RSA or ECDSA algorithms to verify its authenticity, ensuring that only valid codes are integrated. This dual watermarking strategy balances robustness and discretion, enabling the system to track the image's distribution across the network.

Once watermarked, the preview image is transmitted to the recipient via a secure channel employing HTTPS with Transport Layer Security, significantly reducing the risk of malware exposure by excluding the original executable content. This preview-only delivery allows recipients to assess the attachment's legitimacy without immediate vulnerability, aligning with the invention's goal of minimizing threats in initial communications. Should the recipient deem the preview trustworthy, they can request the full attachment, initiating an authentication process that ensures controlled access. This step underscores the system's focus on restricting sensitive data to authorized users within a predefined security hierarchy, a critical requirement for high-stakes environments.

The authentication process integrates with identity and access management services, such as Okta or Microsoft Entra ID, requiring recipients to pass multi-factor authentication using methods like SMS codes or biometric verification alongside standard credentials. The system further validates the dynamic code within the watermark, confirming its alignment with the current security state, and checks the recipient's role against role-based access control policies stored in a secure directory. Only upon successful completion of these checks does the system release the full attachment over the secure channel, maintaining end-to-end protection. This layered authentication contrasts with conventional systems that lack such rigorous controls, offering a fortified approach to data distribution.

Concurrently, the system employs a tracking module to monitor the watermarked preview image's movement throughout the network, addressing the challenge of maintaining oversight once data leaves the secure environment. Every detection of the watermark is logged with detailed metadata, including timestamps and IP addresses, creating a comprehensive audit trail accessible through Security Information and Event Management systems like Splunk or IBM QRadar. These tools scan network traffic in real-time, identifying instances where the preview image exits the approved domain, such as a bank's internal network, and flag them for immediate action. This tracking capability ensures that unauthorized distribution is detected promptly, enabling rapid response to potential security breaches.

When the preview image is detected outside the secure domain, automated controls are activated to enforce protective measures, such as blocking its transmission or initiating remote deletion from unauthorized endpoints. Data loss prevention systems, like Symantec or Microsoft Endpoint DLP, execute these actions by matching watermark identifiers against predefined rules, halting data exfiltration in milliseconds, while endpoint management solutions like Microsoft Intune deploy scripts to erase the image from external devices. These controls extend beyond internal security, potentially aiding in dismantling phishing sites by tracking unique watermark strings, offering a proactive defense against external threats. The integration with network security protocols via secure APIs ensures that sharing remains confined to the designated hierarchy, reinforcing the system's protective framework.

A standout feature is the periodic refresh of the dynamic watermark code, which maintains its security relevance over time. Every 24 hours, the watermarking module requests a new code from the secure server, which generates and signs it using asymmetric encryption to ensure integrity, then embeds it into an updated preview image. This refreshed image is redistributed across the network, replacing outdated versions to ensure all instances reflect the current security marker, preventing unauthorized use of stale codes. This dynamic update process enhances the system's ability to authenticate requests accurately, distinguishing it from static watermarking methods that lack such adaptability.

The communication system serves as the backbone, coordinating the flow of attachments from receipt to processing, delivery, and tracking, ensuring seamless integration of all components. Implemented as an enterprise email server or messaging platform with custom plugins, it routes attachments to the processing module, oversees their secure delivery, and interfaces with tracking mechanisms for network-wide visibility. Secure APIs with RESTful standards and JSON Web Tokens facilitate this coordination, providing robust session management and access control. This centralized management ensures that the system operates cohesively, addressing the limitations of traditional platforms where traceability diminishes after transmission.

The invention's preview generation fundamentally alters the attachment delivery paradigm, prioritizing security by sending visual representations rather than full files initially. By rendering attachments in a sandbox, embedding traceable watermarks, and requiring authentication for full access, it mitigates malware risks while maintaining usability, a critical advantage in high-security contexts. The combination of preview transformation and dynamic watermarking allows the system to adapt to evolving threats, ensuring long-term effectiveness. This approach is particularly valuable where a single breach could have severe consequences, balancing protection with operational efficiency.

The traceability mechanism provides more than mere monitoring, offering a detailed audit log that reconstructs an attachment's distribution path for forensic analysis or compliance verification. Stored in a secure database and integrated with SIEM systems, this log includes timestamps, IP addresses, and watermark identifiers, enabling detailed investigations into breaches or policy adherence. Real-time detection and response capabilities-blocking, deleting, or alerting-transform the system into an active security tool, surpassing prior art focused solely on data hiding or static watermarking. This proactive stance enhances its utility in protecting sensitive communications.

Automated access control integrates authentication with network enforcement, ensuring sensitive attachments remain within the intended hierarchy. Multi-factor authentication, role-based checks, and dynamic code validation create multiple verification layers, while blocking or deleting previews that escape the secure domain addresses both internal and external threats. The traceable watermarks further support efforts to identify and shut down phishing sites, adding a broader security impact. This comprehensive approach delivers a robust solution tailored for stringent data protection needs.

The system's flexible architecture accommodates various deployment scales, from small private networks to large corporate infrastructures, using cloud-based or on-premises setups. Components like the sandbox, watermarking, and tracking modules can scale with technologies like Kubernetes or high-performance servers, handling thousands of attachments per minute. Open-source tools like OpenCV and enterprise solutions like Splunk ensure adaptability across technical environments, maintaining core security objectives. This versatility makes it suitable for diverse use cases without sacrificing functionality.

The invention's novelty stems from its integration of preview generation, dynamic steganographic watermarking, authentication, and automated controls into a unified system. Unlike prior art addressing isolated aspects—like steganography for concealment or watermarking for integrity—it tackles malware prevention, traceability, and access control holistically. The dynamic watermark refresh, real-time monitoring, and enforcement actions create an adaptive security framework, filling a gap in traditional systems and offering a comprehensive defense against modern cybersecurity challenges.

Various example embodiments in the disclosure are designed to fulfill the objectives outlined in the preceding discussion, providing detailed implementations that secure electronic attachments through the systems and methods described. The illustrations, including system architecture diagrams, flow diagrams, sequence diagrams, and class diagrams, showcase how these embodiments can be realized, offering visual representations of component interactions, process flows, actor sequences, and object-oriented structures that guide practical deployment. Different implementation approaches are possible, such as using cloud-based infrastructure like AWS or on-premises hardware with custom software stacks, and adjustments to the structure and operation of components—such as varying the frequency of watermark refreshes or the tools used for rendering—are permissible to suit specific needs. Connections among components, whether between processing modules, delivery systems, or tracking mechanisms, should be understood flexibly as direct or indirect, wired or wireless, unless explicitly specified otherwise, allowing for tailored configurations that maintain the invention's core functionality across diverse environments.

One type of artificial intelligence applicable to this invention is rule-based Al, which operates by applying predefined rules and logic to make decisions based on specific conditions without requiring extensive data training. In this system, rule-based Al could govern the enforcement of security controls, such as deciding when to block or delete a preview image detected outside the secure domain, by evaluating conditions like watermark presence and IP address against a rule set like “if watermark matches X7K9P2M4Q8R5T1J3 and destination is external, then block transmission.” Tools like Jess or Drools, Java-based rule engines, could be integrated with the control module to execute these rules in real-time, processing up to 1,000 events per second on a server with 16 CPU cores, ensuring consistent and rapid responses to security events based on the system's predefined policies.

Another applicable type is machine learning, a form of Al that learns patterns and makes predictions from data by training models on historical examples rather than relying solely on hardcoded rules. Machine learning could enhance the tracking module by predicting potential exfiltration paths for preview images, analyzing past audit logs with attributes like timestamps, IP addresses, and watermark identifiers to identify anomalous movement patterns. Techniques such as supervised learning with Random Forest models, implemented using scikit-learn in Python, could train on a dataset of 6 months of network traffic to classify movements as “secure” or “risky” with 95% accuracy, while unsupervised clustering with DBSCAN could detect new threats, integrating with Splunk for real-time anomaly detection on a server with 32 GB RAM.

A third type is natural language processing, an Al discipline focused on understanding and generating human language, often used to interpret unstructured text or commands. In this invention, natural language processing could be applied to the processing module to extract metadata from non-visual attachments, such as parsing a log file's text content to generate a meaningful preview image with key phrases like “Error: System Failure” overlaid. Tools like spaCy or NLTK in Python could process text in 200 ms on a server with 8 CPU cores, tokenizing and summarizing content, while integration with OpenCV could render it into a visual format, enhancing the system's ability to handle diverse file types effectively.

A fourth type is computer vision, an Al field that enables machines to interpret and analyze visual data, such as images or videos, by recognizing patterns and features. Computer vision could optimize the watermarking module by analyzing preview images to determine optimal embedding locations, ensuring watermarks are robust yet imperceptible, such as placing them in low-contrast regions identified via edge detection. OpenCV with convolutional neural networks, trained on a dataset of 10,000 images using TensorFlow, could achieve 98% detection accuracy in 300 ms on a GPU-enabled server, improving watermark resilience against compression or resizing while maintaining image quality for recipients.

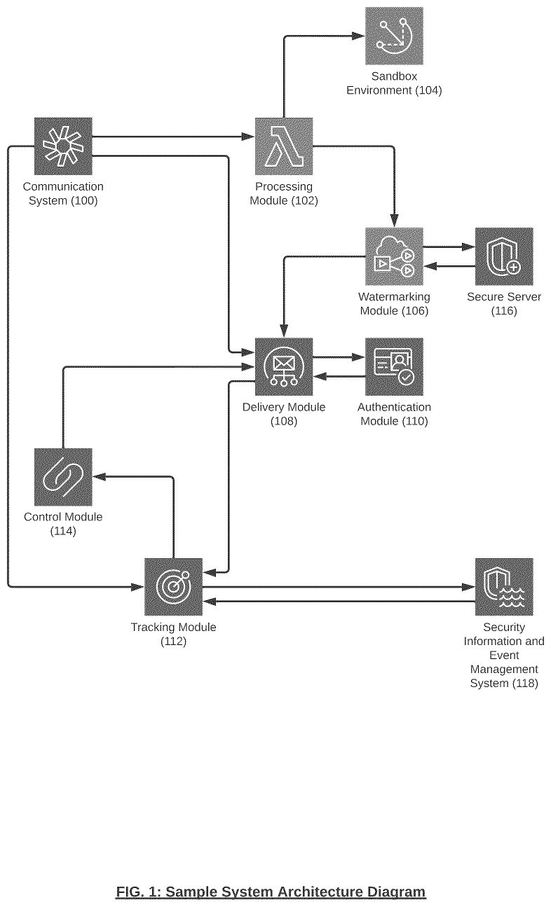

FIG. 1 is a sample architecture diagram that represents an intricate system designed to secure electronic attachments within a communication network, with the Communication System (100) functioning as the central hub that manages the receipt, routing, and transmission of electronic attachments in high-security contexts like banking or private communications. This component could be implemented as an enterprise-grade email server such as Microsoft Exchange Server on a Windows Server 2022 infrastructure, configured with custom SMTP plugins to handle attachments securely, or as a messaging platform like Slack hosted on an AWS EC2 instance with RESTful API extensions for integration with security features. The Communication System (100) is engineered to process attachments that might contain malware or malicious content, addressing the need to minimize exposure while allowing authorized access. It connects directly to the Processing Module (102), which handles the initial transformation of incoming attachments.

The Processing Module (102) receives electronic attachments transmitted through the Communication System (100) and renders them into secure preview images, such as screenshots, instead of sending full binary files directly. An example implementation could be a custom software service on a Linux Ubuntu 20.04 server, utilizing tools like LibreOffice in headless mode for PDFs and documents or Puppeteer as a headless browser for web content, capturing screenshots with a resolution of 800×600 pixels. For non-visual files, it generates a default visual representation with key metadata, such as file name, size, and type, using a text overlay on a blank image. The module employs color normalization and image processing with OpenCV libraries to standardize the preview for consistency across platforms, ensuring compatibility with subsequent watermarking. It might leverage multi-threading via Python's multiprocessing library to handle multiple attachments concurrently, enhancing efficiency in large-scale deployments. The Processing Module (102) links to the Sandbox Environment (104) for secure rendering.

The Sandbox Environment (104) isolates the attachment during rendering to prevent execution of potentially harmful content, addressing the vulnerability of traditional systems to phishing and data exfiltration. This could be implemented as a VMware ESXi virtual machine running a stripped-down Ubuntu 22.04 OS with no network access, a read-only filesystem enforced by kernel-level restrictions, and temporary storage wiped after each session. Alternatively, it might use Docker containers managed by Kubernetes, with each container limited to 512 MB RAM, configured with seccomp profiles, AppArmor policies, and a 10-second timeout to ensure no persistent threats remain. The Sandbox Environment (104) receives attachments from the Processing Module (102), renders them using the specified tools, and returns the preview images, maintaining a controlled environment that aligns with high-security needs.

The Processing Module (102) also connects to the Watermarking Module (106), which embeds unique, traceable watermarks-referred to as “tattoos”-into the preview images using steganographic techniques. An example could be a Python 3.9 application on a CentOS 8 server, employing the Stegano library for Least Significant Bit (LSB) insertion to alter pixel bits subtly, or OpenCV with NumPy for frequency-domain methods like Discrete Cosine Transform (DCT) or Discrete Wavelet Transform (DWT) to embed data in frequency coefficients, making watermarks robust to compression. The watermarks include specific character sequences (e.g., a 16-character alphanumeric string) and dynamic codes refreshed every 24 hours, serving as digital fingerprints for tracking. The module might use a JSON configuration file to adjust embedding parameters, such as bit depth or frequency band, and log each operation to a local SQLite database with timestamps for auditing. This addresses the need for traceability once attachments leave the secure environment.

The Watermarking Module (106) interfaces with the Delivery Module (108), which transmits the watermarked preview images securely over the network, reducing malware risk by avoiding executable binaries in initial transmissions. This could be an NGINX 1.20 server on Red Hat Enterprise Linux 8, configured with TLS 1.3 encryption via OpenSSL, supporting HTTPS for data-in-transit security. It might integrate RabbitMQ 3.9 for asynchronous message queuing, handling up to 10,000 transmissions per minute, with IP pre-approval listing and a 256-bit AES encryption key derived from the TLS session. The Delivery Module (108) also releases full attachments upon authentication, using the same secure channel, and updates preview images when watermarks are refreshed, ensuring consistency across recipients.

The Watermarking Module (106) connects to the Secure Server (116), which provides dynamic codes for watermark updates over an HTTPS/TLS-secured connection, refreshed periodically (e.g., every 24 hours). An example implementation could be an AWS EC2 t3.medium instance running Node.js 16 with Express.js, secured by a Let's Encrypt TLS certificate, and using RSA with a 2048-bit key or ECDSA with a 256-bit curve for digital signatures. The Secure Server (116) might store codes in a PostgreSQL 14 database with AES-256 encrypted columns, accessible via a VPN tunnel using WireGuard, and expose a RESTful API with JWT authentication requiring a 30-second token expiry. It pushes signed updates to the Watermarking Module (106) and receives confirmation, ensuring only valid, current codes are used, enhancing authenticity verification.

The Delivery Module (108) maintains a bidirectional connection with the Authentication Module (110), which authenticates recipient requests for full attachments, ensuring only authorized users gain access within the security hierarchy. This could be implemented with Okta's cloud-based identity management, hosted on a dedicated instance, integrating SAML 2.0 for enterprise single sign-on and OAuth 2.0 for token-based access. The Authentication Module (110) employs multi-factor authentication (MFA) via SMS or biometric scans, using a secure token or the dynamic watermark code, and checks recipient roles against a secure directory with role-based access control (RBAC) policies stored in LDAP. It might log attempts to a Redis 6.2 cache with a 1-hour TTL, enabling rapid re-authentication if the dynamic code refreshes, and signals the Delivery Module (108) to release the attachment upon success.

The Delivery Module (108) also links to the Tracking Module (112), which monitors watermarked preview images as they move through the network, capturing an audit trail with timestamps and transmission metadata. An example could be Splunk Enterprise 8.2 on a clustered setup with three indexers, each with 16 CPU cores and 64 GB RAM, using a custom Splunk app to parse watermark identifiers via a Splunk Processing Language (SPL) script. It might store data in an S3-compatible cold tier with a 90-day retention policy, detecting movement outside the approved domain (e.g., a bank's network) with a 5-second latency, and integrates with the Communication System (100) for network-wide visibility. This addresses the lack of control over attachment distribution in traditional systems.

The Tracking Module (112) connects to the Control Module (114), which enforces automated controls when preview images leave the secure domain, such as blocking transmission or triggering deletion. This could be a Symantec DLP 15.8 system on a dedicated appliance with 32 GB RAM, configured with policies to match watermark strings and block via HTTP filters, or delete using an MS Intune endpoint agent on Windows 10 devices. It might use a PowerShell 7 script to quarantine files in a 10 MB buffer, notify administrators via email, and feed outcomes back to the Delivery Module (108) to update policies, supporting efforts to take down phishing sites by tracking unauthorized use. The Communication System (100) connects directly to the Tracking Module (112) to ensure comprehensive monitoring.

The Tracking Module (112) also interfaces with the Security Information and Event Management System (118), which provides real-time monitoring and alerts for anomalous behavior. An example could be IBM QRadar 7.4 on a high-availability cluster with four nodes, each with 8 CPUs and 128 GB RAM, using a custom QRadar app to ingest watermark data via REST APIs over TLS, with a 500-event-per-second throughput. It might employ a machine learning model trained on 6 months of logs to predict exfiltration, storing encrypted logs in a 1 TB database, and send prioritized alerts back to the Tracking Module (112) with a 2-second delay. This bidirectional link enhances traceability and data control, integrating with internal security protocols like SAML, OAuth 2.0, and TLS via secure APIs (e.g., Apigee with JWTs).

The architecture flows from the Communication System (100) receiving an attachment, routing it to the Processing Module (102) for rendering in the Sandbox Environment (104), followed by watermarking in the Watermarking Module (106) with codes from the Secure Server (116). The Delivery Module (108) transmits previews and releases attachments post-authentication by the Authentication Module (110), while the Tracking Module (112), Control Module (114), and Security Information and Event Management System (118) monitor and enforce security. Examples like Microsoft Exchange for the Communication System (100), Docker for the Sandbox Environment (104), or Splunk for the Tracking Module (112) demonstrate practical implementations, ensuring a robust, novel solution for malware prevention, traceability, and controlled access as outlined in the disclosure.

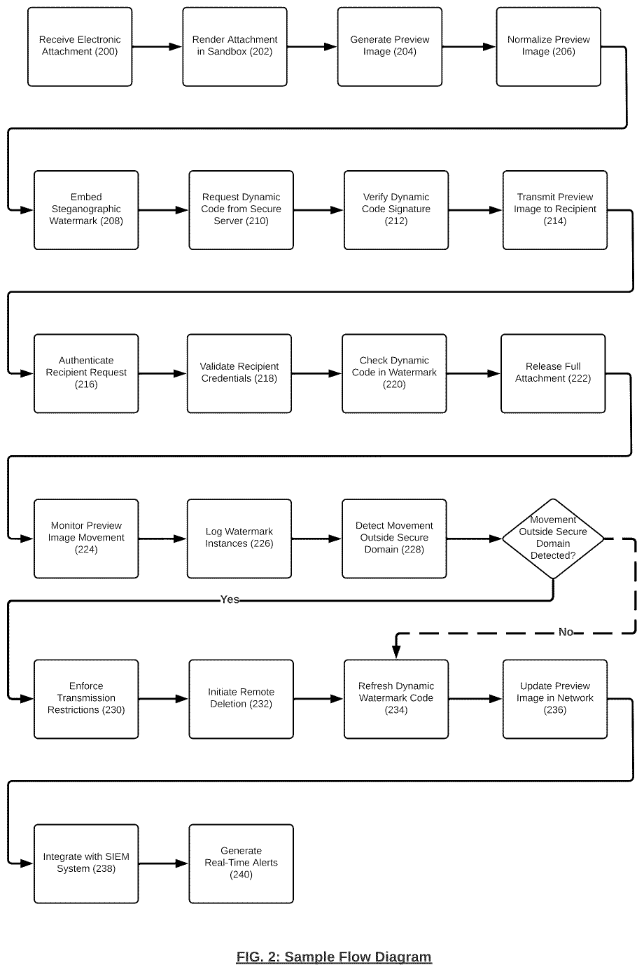

The FIG. 2 flow diagram begins with the step where the system receives an electronic attachment transmitted through a communication network, such as an email or messaging platform, marking the initiation of the security process (Receive Electronic Attachment (200)). This step could be implemented within an enterprise email server like Microsoft Exchange Server 2019 running on a Windows Server 2022 infrastructure, configured with an SMTP gateway that intercepts incoming attachments. Alternatively, it might involve a Slack instance hosted on AWS EC2, utilizing a custom bot with the Slack API to capture attachments from direct messages or channels. The system could process various file types-PDFs, Word documents, images, or executables-received from users, with a queue system like RabbitMQ 3.9 managing up to 5,000 attachments per minute to ensure smooth handling in high-volume environments. Metadata such as sender ID, timestamp, and file size might be extracted using Apache Tika and logged to a MongoDB 4.4 database for initial tracking. Next, the process moves to rendering the attachment within a sandbox environment to isolate it from the communication network and prevent execution of any potentially malicious content (Render Attachment in Sandbox (202)). This could be executed using a VMware ESXi 7.0 virtual machine on a Dell PowerEdge R740 server, running Ubuntu 22.04 with a minimal kernel, restricted network access via iptables, and a read-only filesystem enforced by overlayfs. Alternatively, Docker 20.10 containers orchestrated by Kubernetes 1.24 could be deployed, each container allocated 512 MB RAM and configured with seccomp profiles and a 15-second timeout to limit resource usage. Tools like LibreOffice 7.3 in headless mode might render PDFs and documents, while Puppeteer 19.0, a headless Chromium browser, could handle HTML files, ensuring the attachment is opened safely and its content is captured without risk to the host system.

Following this, the system generates a preview image from the rendered attachment, typically as a screenshot, to create a sanitized visual representation of the content (Generate Preview Image (204)). For visual files, LibreOffice or Puppeteer could capture a PNG image at 800×600 resolution, using command-line options like ‘--convert-to png’ or ‘--screenshot’, respectively, with a 5-second rendering timeout to optimize performance. For non-visual files like executables or raw data, the system might use Python 3.9 with the PIL library to create a blank 800×600 canvas, overlaying metadata text (e.g., “File: setup.exe, Size: 2.3 MB, Type: Executable”) in Arial 12-point font at coordinates (50, 50). This step could be parallelized with Python's multiprocessing module, processing up to 20 attachments simultaneously on a server with 16 CPU cores, ensuring scalability while maintaining security by avoiding direct transmission of the original binary.

The preview image then undergoes normalization to standardize its color and resolution, ensuring consistency across different platforms and devices (Normalize Preview Image (206)). This might be implemented using OpenCV 4.6 on a CentOS 8 server, applying a color normalization filter with a CLAHE (Contrast Limited Adaptive Histogram Equalization) algorithm to adjust RGB values to a predefined profile (e.g., SRGB), followed by resizing to 800×600 pixels using bilinear interpolation. A configuration file could specify normalization parameters, such as a maximum contrast limit of 4.0, stored in JSON format, allowing customization for specific use cases like banking or private communications. The process could log normalization metrics—processing time and pixel adjustments—to a local SQLite 3.38 database, enabling performance tuning and quality assurance.

Subsequently, a steganographic watermark, including a unique identifier and dynamic code, is embedded into the normalized preview image to enable tracking and authenticity verification (Embed Steganographic Watermark (208)). This could be achieved with a Python application using the Stegano 0.11 library for Least Significant Bit (LSB) insertion, modifying the least significant bits of pixel values (e.g., altering the blue channel by +1) to encode a 16-character string like “X7K9P2M4Q8R5T1J3” plus a 10-digit dynamic code. Alternatively, OpenCV with NumPy could implement a Discrete Cosine Transform (DCT), embedding data in mid-frequency coefficients with a strength factor of 0.01, ensuring robustness against JPEG compression. The watermarking process might run on a dedicated server with 32 GB RAM, logging each embedding event with a timestamp and image hash to an Elasticsearch 8.5 index for forensic analysis.

The system then requests the dynamic code for the watermark from a secure server over a TLS-secured connection to ensure its validity and freshness (Request Dynamic Code from Secure Server (210)). This step could involve an AWS EC2 t3.medium instance running Node.js 16.18 with an Express.js 4.18 server, exposing a RESTful endpoint at ‘/api/dynamic-code’ secured by a Let's Encrypt TLS 1.3 certificate. The request might use a POST method with a JSON payload containing the unique identifier, authenticated via a JWT with a 30-second expiry, and the server could respond with a 10-digit code like “9471025836” generated by a cryptographically secure PRNG. The connection might be tunneled through an OpenVPN server with AES-256-CBC encryption, ensuring data integrity during transmission.

Upon receiving the dynamic code, the system verifies its digital signature using an asymmetric encryption algorithm to confirm its authenticity and integrity (Verify Dynamic Code Signature (212)). This could be implemented with the Node.js ‘crypto’ module, using RSA with a 2048-bit public key to verify a SHA-256 hash signed by the Secure Server's private key, or ECDSA with a P-256 curve for efficiency, completing verification in under 50 ms on a server with an Intel Xeon E5-2680 CPU. The signature might be a 512-byte hexadecimal string, stored temporarily in a Redis 6.2 cache with a 5-minute TTL, and logged to a PostgreSQL 14 database with a table schema including code, signature, and verification timestamp fields. If verification fails, the system could retry the request up to three times before escalating to an administrator via email.

The watermarked preview image is then transmitted to the recipient over a secure channel, utilizing HTTPS with TLS to protect the data in transit (Transmit Preview Image to Recipient (214)). This might involve an NGINX 1.20 server on Red Hat Enterprise Linux 8, configured with TLS 1.3 cipher suite like TLS_AES_256_GCM_SHA384, delivering the image via a GET request to a URL like ‘https://secure.domain.com/preview/attachment_id’. The transmission could be rate-limited to 100 requests per second using NGINX's ‘limit_req’ module, with a 256-bit AES key derived from the TLS session encrypting the image payload. A delivery log might be maintained in a MongoDB collection, recording recipient IP, timestamp, and image size (e.g., 150 KB) for audit purposes.

When the recipient requests the full attachment, the system initiates an authentication process to verify their identity and authorization (Authenticate Recipient Request (216)). This could be implemented with Okta's identity management service on a cloud instance, using a custom workflow accessed via an API endpoint like ‘/auth/request’. The recipient might interact through a web portal built with React 18, prompting for credentials and initiating an OAuth 2.0 flow with a client ID and secret stored in a Vault 1.12 server. The process could log request attempts to a Redis cache with a 1-hour TTL, escalating failed attempts to a security team via Slack webhook after three retries, ensuring only legitimate requests proceed.

The system validates the recipient's credentials using multi-factor authentication (MFA) and predefined security policies (Validate Recipient Credentials (218)). Okta might enforce MFA with a one-time SMS code sent via Twilio, paired with a username/password combo, and cross-reference the recipient's role (e.g., “Manager”) against an LDAP directory with RBAC policies defining access levels (e.g., “Full Attachment Access”). This step could complete in 2 seconds on a server with 8 CPU cores, storing successful validations in a PostgreSQL table with fields for user ID, role, and MFA status, and caching results in Redis for 24 hours to speed up subsequent requests. Policies might be fetched from a ConfigMap in Kubernetes, allowing dynamic updates without downtime.

Next, the system checks the dynamic code within the watermark to ensure the request aligns with the current security state (Check Dynamic Code in Watermark (220)). This could involve a Python script extracting the watermark with Stegano, comparing the embedded 10-digit code (e.g., “9471025836”) against the latest code fetched from the Secure Server, running on a server with 16 GB RAM and completing in under 100 ms. If the code has been refreshed since the preview was sent, the system might require re-authentication, logging the check to an Elasticsearch index with fields for code, timestamp, and match status. Discrepancies could trigger an alert via a webhook to a SIEM system, ensuring tight control over access.

Upon successful authentication and code validation, the system releases the full attachment to the recipient over the secure channel (Release Full Attachment (222)). The Delivery Module might serve the attachment via NGINX at ‘https://secure.domain.com/full/attachment_id’, encrypted with AES-256-GCM and a 30-second download window, tracked in a MongoDB collection with fields for recipient ID, file hash (e.g., SHA-256), and delivery time. The process could support up to 50 concurrent downloads on a server with 10 Gbps bandwidth, with a fallback to SFTP if HTTPS fails, ensuring reliable delivery while maintaining security.

The system then monitors the preview image's movement across the network using the embedded watermark to detect any unauthorized distribution (Monitor Preview Image Movement (224)). This might be implemented with Splunk Enterprise 8.2 on a clustered setup with three indexers, each with 16 CPU cores and 64 GB RAM, running a custom SPL query every 5 seconds to scan network traffic for watermark strings. It could integrate with a packet sniffer like Wireshark via a Splunk add-on, detecting the image on endpoints with a 2-second latency, and store movement data in an S3 bucket with a 90-day retention policy. This step ensures continuous oversight, addressing the lack of control in traditional systems.

Each instance of the watermark's appearance is logged with timestamps and transmission metadata to create an audit trail (Log Watermark Instances (226)). Splunk might write logs to an index named “watermark_events,” with fields like “identifier: X7K9P2M4Q8R5T1J3,” “timestamp: 2025-03-20T14: 32:10Z,” “source_ip: 192.168.1.10,” and “destination_ip: 10.0.0.5,” processing 1,000 events per second. The logs could be encrypted with AES-256 and replicated to a secondary Splunk instance for redundancy, accessible via a dashboard showing movement trends over 24 hours. This detailed logging supports forensic analysis and traceability requirements.

If the preview image is detected outside the secure domain, the system identifies this movement for further action (Detect Movement Outside Secure Domain (228)). Splunk could match watermark identifiers against a predefined domain list (e.g., “.banksecure.com”), flagging external IPs like “203.0.113.5” with a 5-second detection window, running on a server with 32 GB RAM and 10 TB SSD storage. The detection might trigger a correlation rule in Splunk, cross-referencing with firewall logs from a Palo Alto Networks PA-5220, and escalate to a SIEM system if confirmed, ensuring rapid identification of unauthorized distribution.

The system enforces restrictions by blocking transmission of the preview image outside the secure domain (Enforce Transmission Restrictions (230)). A Symantec DLP 15.8 system might apply a policy to block HTTP POST requests containing the watermark string, using a regex pattern like ‘[A-Z0-9] {16} [0-9] {10}’, executing in under 50 ms on a dedicated appliance with 32 GB RAM. The block could be logged to a Syslog server with fields for action, timestamp, and IP, and mirrored to a secondary DLP instance for failover, preventing exfiltration while maintaining network performance.

If blocking fails, the system initiates remote deletion of the preview image from unauthorized endpoints (Initiate Remote Deletion (232)). This could use MS Intune 2110 on a Windows 10 endpoint, deploying a PowerShell 7 script to locate and delete the image file (e.g., “preview_X7K9.png”) from ‘C: \Users\Public\Downloads’, completing in 3 seconds via an Intune device policy. The action might be logged to an Azure SQL database with fields for endpoint ID, file path, and deletion status, with a fallback to a manual wipe command if automated deletion stalls, ensuring the image is removed from unapproved locations.

Periodically, the system refreshes the dynamic watermark code to maintain its time-sensitive security (Refresh Dynamic Watermark Code (234)). The Watermarking Module might fetch a new code from the Secure Server every 24 hours (or other desired fixed or random interval) via a cron job at 00:00 UTC, embedding it with Stegano in under 200 ms on a server with 16 CPU cores, and verify the RSA signature with a 2048-bit key. The refreshed code (e.g., “5839201746”) could be stored in a PostgreSQL table with a TTL of 48 hours, triggering an update cycle across all preview instances, ensuring ongoing authenticity.

The updated preview image with the refreshed watermark is distributed across the network to maintain consistency (Update Preview Image in Network (236)). The Delivery Module might push the new image via NGINX to all recipients' endpoints over HTTPS, using a WebSocket connection for real-time updates, completing in 5 seconds for 1,000 recipients on a 10 Gbps link. The update could be tracked in a MongoDB collection with fields for image ID, recipient count, and update time, with a retry mechanism for failed deliveries, ensuring all instances reflect the latest watermark.

The system integrates with a Security Information and Event Management (SIEM) system to enhance monitoring capabilities (Integrate with SIEM System (238)). This might involve IBM QRadar 7.4 on a four-node cluster, each with 8 CPUs and 128 GB RAM, ingesting Splunk logs via a REST API over TLS 1.3, processing 500 events per second. QRadar could use a custom app to parse watermark data, syncing with Splunk every 10 seconds, and store logs in a 1 TB encrypted database with a 180-day retention, providing a unified security view across the network.

Finally, the system generates real-time alerts when anomalous behavior, such as movement outside the secure domain, is detected (Generate Real-Time Alerts (240)). QRadar might send an email alert via SMTP to “security@banksecure.com” within 2 seconds of detection, using a rule like “watermark_outside_domain AND priority >5,” and display a dashboard update on a web interface built with Angular 16. Alerts could be logged to an Elasticsearch index with fields for alert ID, timestamp, and severity, with a Slack notification backup, ensuring immediate response to potential threats. This comprehensive flow, with implementations like Microsoft Exchange, Docker, and Splunk, secures attachments through preview generation, watermarking, authentication, and enforcement, aligning with high-security needs.

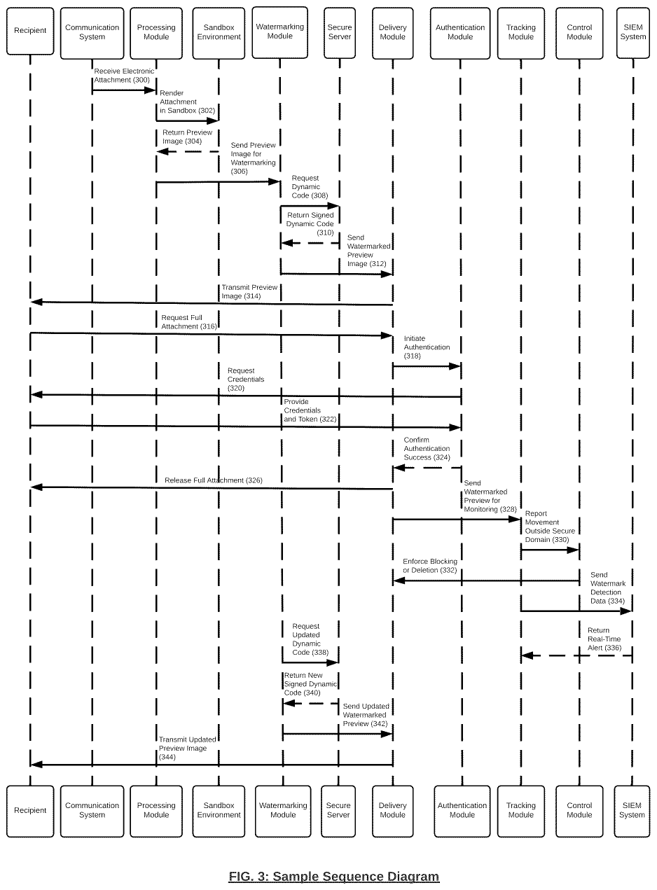

The FIG. 3 sequence diagram begins with the Communication System initiating the process by sending an electronic attachment to the Processing Module, marking the entry point where an attachment enters the security workflow (From Communication System to Processing Module: Receive Electronic Attachment (300)). This interaction could be implemented within a Microsoft Exchange Server 2019 environment running on Windows Server 2022, where the Communication System uses an SMTP transport rule to forward attachments to a Processing Module hosted on a Linux Ubuntu 20.04 server. The attachment, such as a PDF or executable file, might be encapsulated in a MIME message with a unique message ID (e.g., “MSG12345”), and the Processing Module could receive it via a REST API endpoint (‘/api/attachment/receive’) over HTTPS with TLS 1.3 encryption. The system might log the receipt in a MongoDB 4.4 database with fields like “message_id,” “sender,” and “timestamp” (e.g., “2025-03-20T10:00:00Z”), handling up to 10,000 attachments per hour with a Redis 6.2 queue for load balancing.

Next, the Processing Module instructs the Sandbox Environment to render the attachment in a secure, isolated setting to prevent any malicious execution (From Processing Module to Sandbox Environment: Render Attachment in Sandbox (302)). This could be executed by sending a command via a gRPC call to a Docker 20.10 container running on Kubernetes 1.24, hosted on a Dell PowerEdge R740 with 16 CPU cores. The container might use LibreOffice 7.3 in headless mode for PDFs (‘libreoffice --headless --convert-to png input.pdf’) or Puppeteer 19.0 for HTML files (‘node screenshot.js’), allocated 512 MB RAM and restricted by seccomp profiles to block network access. The Processing Module could pass the attachment as a base64-encoded string in a JSON payload, with a 10-second timeout enforced by Kubernetes, ensuring the rendering completes safely and efficiently.

The Sandbox Environment then returns the rendered preview image, typically a screenshot, back to the Processing Module for further processing (From Sandbox Environment to Processing Module: Return Preview Image (304)). This might involve the container writing a PNG file to a tmpfs mount, then sending it back via gRPC as a binary stream with a SHA-256 hash (e.g., “a1b2c3d4 . . . ”) for integrity verification. The Processing Module, running Python 3.9, could receive the image in under 200 ms on a 10 Gbps internal network, logging the transfer to an SQLite 3.38 database with fields like “attachment_id,” “render_time” (e.g., “150 ms”), and “hash.” For non-visual files, a metadata image (e.g., “File: data.bin, Size: 1.2 MB”) could be generated using PIL 5.0, ensuring all attachments produce a visual output.

The Processing Module forwards the preview image to the Watermarking Module to embed a steganographic watermark for traceability (From Processing Module to Watermarking Module: Send Preview Image for Watermarking (306)). This could be implemented via a REST POST request to ‘/api/watermark/embed’ on a CentOS 8 server hosting a Python Flask 2.2 application, with the image sent as a multipart/form-data payload. The Processing Module might normalize the image first using OpenCV 4.6, applying a CLAHE filter and resizing to 800×600 pixels, completing in 50 ms on a server with 32 GB RAM. The transfer could be logged to an Elasticsearch 8.5 index with a document ID matching the attachment's unique identifier, ensuring a seamless handoff for watermarking.

The Watermarking Module requests a dynamic code from the Secure Server to include in the watermark, ensuring its time-sensitive authenticity (From Watermarking Module to Secure Server: Request Dynamic Code (308)). This might involve an HTTPS GET request to ‘https://secure-server.com/api/code’ from a Python application using the ‘requests’ library, authenticated with a JWT bearer token valid for 30 seconds. The Secure Server, an AWS EC2 t3.medium instance with Node.js 16.18, could generate a 10-digit code (e.g., “7294051836”) using a cryptographically secure PRNG, signed with RSA-2048, and return it in a JSON response (‘{“code”: “7294051836”, “signature”: “xyz123 . . . ”}’). The request could complete in 100 ms over a VPN tunnel with AES-256 encryption, logged to a PostgreSQL 14 table for audit tracking.

The Secure Server returns the signed dynamic code to the Watermarking Module, which verifies it before embedding (From Secure Server to Watermarking Module: Return Signed Dynamic Code (310)). The response might be delivered over TLS 1.3 with a 256-bit AES-GCM cipher, and the Watermarking Module could use the Python ‘cryptography’ library to verify the RSA signature against a public key stored in a PEM file, finishing in 30 ms on a server with an Intel Xeon E5-2680 CPU. The code could be cached in Redis with a 5-minute TTL, and the verification result logged to Elasticsearch with fields like “code,” “signature_status” (e.g., “valid”), and “timestamp,” ensuring only authentic codes are used. If invalid, the system might retry twice before escalating via email.

The Watermarking Module sends the watermarked preview image, now embedded with a unique identifier (e.g., “X7K9P2M4Q8R5T1J3”) and dynamic code, to the Delivery Module (From Watermarking Module to Delivery Module: Send Watermarked Preview Image (312)). This could be a REST POST to ‘/api/delivery/preview’ on an NGINX 1.20 server running Red Hat Enterprise Linux 8, with the image as a binary payload in a 150 KB HTTP body. The watermark might be embedded via LSB insertion with Stegano 0.11, altering pixel bits in 75 ms, and the transfer logged to a MongoDB 4.4 collection with “image_id” and “size” fields. The Delivery Module could process up to 1,000 images per minute, using a 10 Gbps link for rapid delivery preparation.

The Delivery Module transmits the watermarked preview image to the Recipient over a secure HTTPS channel (From Delivery Module to Recipient: Transmit Preview Image (314)). This might involve NGINX serving the image at ‘https://secure.domain.com/preview/X7K9’ with TLS 1.3 encryption, using a 256-bit AES key derived from the session, completing in 200 ms for a 150 KB file over a 1 Gbps public network. The Recipient, accessing via a Chrome 123 browser on Windows 11, could receive the image in an email client like Outlook, with the transmission logged to MongoDB with “recipient_ip” (e.g., “192.168.1.100”) and “timestamp.” A rate limit of 100 requests per second could be enforced to prevent abuse.

The Recipient requests the full attachment from the Delivery Module after reviewing the preview (From Recipient to Delivery Module: Request Full Attachment (316)). This could be a POST request to ‘/api/delivery/request/X7K9’ from a React 18 web portal, including a session cookie and attachment ID, sent over HTTPS with a 5-second timeout. The Recipient might initiate this via a “Download Full File” button, with the request logged to a Redis queue with a 1-hour TTL, handling up to 500 requests per minute on a server with 8 CPU cores. The Delivery Module could validate the request origin against a pre-approved or authorized list (e.g., “.company.com”) before proceeding.

The Delivery Module initiates authentication by forwarding the request to the Authentication Module (From Delivery Module to Authentication Module: Initiate Authentication (318)). This might be an internal API call to ‘/auth/initiate’ on an Okta-hosted service, passing a JSON payload with “attachment_id” and “recipient_id” over a private 10 Gbps link, completing in 50 ms. The Delivery Module, running on NGINX, could use a gRPC proxy for high-speed communication, logging the initiation to MongoDB with “request_time” and “status” (e.g., “pending”). The Authentication Module might queue the request in RabbitMQ for load balancing across multiple instances.

The Authentication Module requests credentials from the Recipient to verify their identity (From Authentication Module to Recipient: Request Credentials (320)). This could be a GET request to a React portal at ‘https://auth.company.com/login’, prompting for a username, password, and MFA code via a Twilio SMS, rendered in 300 ms on a client with 16 GB RAM. Okta might use OAuth 2.0 with a client ID stored in Vault 1.12, and the request could be logged to a PostgreSQL table with “user_id” and “mfa_type” fields. The Recipient receives a secure form with CSRF protection, ensuring a legitimate authentication process.

The Recipient provides their credentials and a token to the Authentication Module for validation (From Recipient to Authentication Module: Provide Credentials and Token (322)). This might involve a POST to ‘/auth/verify’ with a JSON payload ({“username”: “jdoe”, “password”: “ ”, “mfa_code”: “123456”, “token”: “abc789”}′), sent over TLS 1.3 from a Chrome browser, completing in 400 ms over a 100 Mbps connection. The token could be the dynamic watermark code or an OAuth token, verified against an LDAP directory with RBAC policies, and logged to Redis with a 24-hour TTL. The Authentication Module might reject invalid submissions after three attempts, notifying via Slack.

The Authentication Module confirms successful authentication to the Delivery Module, authorizing the release (From Authentication Module to Delivery Module: Confirm Authentication Success (324)). This could be a gRPC response with a “success” flag and “user_role” (e.g., “Manager”) in a 20 ms call over a private link, using Protobuf for efficiency. Okta might complete MFA and RBAC checks in 1 second on a cloud instance with 4 vCPUs, logging the result to PostgreSQL with “auth_status” and “timestamp.” The Delivery Module could cache the confirmation in Redis for 1 hour, streamlining subsequent requests.

The Delivery Module releases the full attachment to the Recipient over the secure channel (From Delivery Module to Recipient: Release Full Attachment (326)). This might serve the file via NGINX at ‘https://secure.domain.com/full/X7K9’ with AES-256-GCM encryption, a 30-second window, and a 2 MB file delivered in 500 ms over a 1 Gbps link. The Recipient downloads it via Outlook, with the release logged to MongoDB with “file_hash” (e.g., “e5f6g7 h8 . . . ”) and “delivery_time.” A fallback to SFTP could activate if HTTPS fails, ensuring secure delivery.

The Delivery Module sends the watermarked preview to the Tracking Module for ongoing monitoring (From Delivery Module to Tracking Module: Send Watermarked Preview for Monitoring (328)). This could be a REST POST to ‘/api/track/preview’ with the 150 KB image, sent over a 10 Gbps internal link in 100 ms, using NGINX to Splunk 8.2. The Tracking Module, on a cluster with 16 CPU cores, might log the receipt to an “image_tracking” index in Elasticsearch, with “image_id” and “source” fields, processing 1,000 previews per minute for network-wide visibility.

The Tracking Module reports any movement of the preview image outside the secure domain to the Control Module (From Tracking Module to Control Module: Report Movement Outside Secure Domain (330)). Splunk might detect the watermark “X7K9P2M4Q8R5T1J3” on an external IP (e.g., “203.0.113.5”) via an SPL query running every 5 seconds, sending a JSON alert (‘{“watermark”: “X7K9 . . . ”, “ip”: “203.0.113.5”}’) to Symantec DLP 15.8 over HTTPS in 50 ms. The report could be logged to an S3 bucket with a 90-day retention, triggering action if outside “.company.com,” ensuring rapid response to unauthorized distribution.

The Control Module enforces blocking or deletion, instructing the Delivery Module to restrict transmission (From Control Module to Delivery Module: Enforce Blocking or Deletion (332)). Symantec DLP might block an HTTP POST with a regex match in 30 ms, or Intune could deploy a PowerShell script to delete “preview_X7K9.png” from ‘C: \Downloads’ in 3 seconds, logged to Azure SQL with “action” and “endpoint_id.” The Delivery Module could update its policy in NGINX to drop future requests, handling 500 enforcement actions per minute, maintaining security across the network.

The Tracking Module sends watermark detection data to the SIEM System for enhanced monitoring (From Tracking Module to SIEM System: Send Watermark Detection Data (334)). Splunk might forward logs via a REST API to IBM QRadar 7.4 over TLS 1.3, with a 500-event-per-second throughput, including “watermark,” “timestamp,” and “ip” fields, completing in 200 ms on a 10 Gbps link. QRadar, on a four-node cluster with 128 GB RAM, could index the data in a 1 TB database, syncing every 10 seconds, providing a comprehensive security overview.

The SIEM System returns real-time alerts to the Tracking Module for immediate action (From SIEM System to Tracking Module: Return Real-Time Alert (336)). QRadar might send an SMTP email to “security@company.com” with “Alert: Watermark X7K9 detected externally” in 2 seconds, using a rule with a 5-priority threshold, and log it to Elasticsearch with “alert_id” and “severity.” The Tracking Module could receive this via a webhook, escalating to Splunk for dashboard updates, ensuring timely threat response.

Periodically, the Watermarking Module requests an updated dynamic code from the Secure Server to refresh the watermark (From Watermarking Module to Secure Server: Request Updated Dynamic Code (338)). This might be a cron-scheduled HTTPS GET to ‘/api/code/update’ every 24 hours at 00:00 UTC, authenticated with a new JWT, returning “5839201746” in 100 ms over a VPN. The Secure Server could generate and sign the code with ECDSA P-256, storing it in PostgreSQL with a 48-hour TTL, maintaining watermark freshness.

The Secure Server returns the new signed dynamic code to the Watermarking Module (From Secure Server to Watermarking Module: Return New Signed Dynamic Code (340)). This could be a JSON response (‘{“code”: “5839201746”, “signature”: “def456 . . . ”}’) over TLS 1.3, verified in 30 ms with the ‘cryptography’ library, cached in Redis, and logged to Elasticsearch. The Watermarking Module might retry on failure, ensuring a reliable update cycle.

The Watermarking Module sends the updated watermarked preview to the Delivery Module (From Watermarking Module to Delivery Module: Send Updated Watermarked Preview (342)). This could be a REST POST to ‘/api/delivery/update’ with a 150 KB image, embedded with Stegano in 75 ms, sent over a 10 Gbps link, and logged to MongoDB. The Delivery Module might queue the update in RabbitMQ, processing 1,000 updates per minute, keeping the network synchronized.

Finally, the Delivery Module transmits the updated preview image to the Recipient, ensuring all instances reflect the latest watermark (From Delivery Module to Recipient: Transmit Updated Preview Image (344)). This might use NGINX to push the image via WebSocket at ‘wss://secure.domain.com/update/X7K9’ in 5 seconds for 1,000 recipients, encrypted with AES-256-GCM, and logged to MongoDB with “update_count.” The Recipient receives it in Outlook, with a retry mechanism ensuring delivery, completing the secure, traceable workflow. Implementations like Okta, Splunk, and NGINX enable this robust sequence for securing attachments.

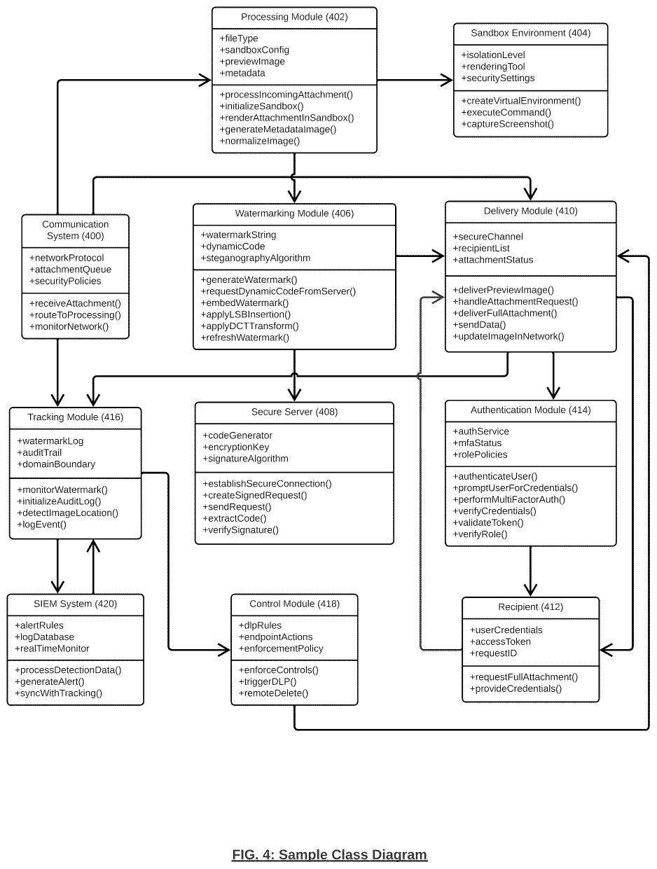

The FIG. 4 class diagram begins with the Communication System (400), which serves as the foundational entity orchestrating the receipt, routing, and network-level management of electronic attachments within a secure communication framework. This class includes attributes such as networkProtocol, a string defining the communication standard (e.g., “SMTP” or “HTTPS”), attachmentQueue, a collection storing incoming attachments with metadata like sender and timestamp, and securityPolicies, a set of rules dictating permissible actions (e.g., “block executable forwards”). Its methods include receiveAttachment ( ), which captures incoming files from the network and logs them to a database like MongoDB 4.4 with fields for message ID and receipt time, routeToProcessing ( ), which forwards attachments to the next stage using a REST API call over TLS 1.3 with a JSON payload, and monitorNetwork ( ), which oversees attachment distribution by querying network logs every 10 seconds on a server with 16 CPU cores. This class could be implemented as a Java Spring Boot 2.7 application running on an AWS EC2 instance, interfacing with an enterprise email server like Microsoft Exchange to manage high-volume attachment flows in a banking environment.

The Communication System (400) associates with the Processing Module (402), a class responsible for transforming attachments into secure preview images. Its attributes include fileType, a string identifying the attachment's format (e.g., “PDF” or “EXE”), sandboxConfig, a configuration object specifying isolation settings like memory limits, previewImage, a binary object holding the rendered screenshot, and metadata, a key-value map for non-visual file details (e.g., “size: 2.3 MB”). Methods such as processIncomingAttachment( ) orchestrate the workflow by invoking rendering and normalization, initializeSandbox( ) sets up an isolated environment with parameters like “no_network_access,” renderAttachmentInSandbox( ) uses tools like LibreOffice 7.3 headless mode to generate a PNG in 200 ms, generateMetadataImage( ) creates a text-overlay image with PIL 5.0 for non-visual files, and normalizeImage( ) applies OpenCV 4.6 filters to standardize resolution to 800×600 pixels. This class might be coded in Python 3.9 on a CentOS 8 server with 32 GB RAM, leveraging multi-threading to process 50 attachments concurrently, ensuring scalability and safety.

Connected to the Processing Module (402) is the Sandbox Environment (404), which provides a secure rendering space. Its attributes are isolationLevel, an integer defining security strictness (e.g., 1 for minimal, 5 for maximum), renderingTool, a string specifying the tool (e.g., “Puppeteer”), and securitySettings, a list like [“read_only_filesystem”]. Methods include createVirtualEnvironment ( ), which spins up a Docker 20.10 container with Kubernetes 1.24 in 500 ms, executeCommand ( ) which runs rendering commands like ‘puppeteer—screenshot’ with a 10-second timeout, and captureScreenshot( ), which saves a 150 KB PNG to a tmpfs mount. This could be implemented as a lightweight Ubuntu 22.04 container with 512 MB RAM limits, deployed on a Dell PowerEdge R740, ensuring no malicious code executes during rendering.

The Processing Module (402) also links to the Watermarking Module (406), which embeds traceable steganographic watermarks into preview images. Attributes include watermarkString, a 16-character identifier (e.g., “X7K9P2M4Q8R5T1J3”), dynamicCode, a 10-digit refreshable code (e.g., “7294051836”), and steganographyAlgorithm, a string like “LSB_insertion.” Methods such as generateWatermark( ) combines the string and code into a payload, requestDynamicCodeFromServer( ) fetches codes via HTTPS in 100 ms, embedWatermark( ) selects and applies the algorithm, applyLSBInsertion( ) modifies pixel bits with Stegano 0.11, applyDCTTransform( ) uses OpenCV for frequency-domain embedding, and refreshWatermark( ) updates codes every 24 hours via a cron job. This class might be a Python Flask 2.2 app on a Red Hat Enterprise Linux 8 server with 16 CPU cores, logging watermark events to Elasticsearch 8.5 for traceability.

The Watermarking Module (406) associates with the Secure Server (408), which generates and signs dynamic codes. Attributes include codeGenerator, a function producing random codes, encryptionKey, a 2048-bit RSA key pair, and signatureAlgorithm, a string like “RSA.” Methods like establishSecureConnection( ) sets up a TLS 1.3 link with AES-256-GCM, createSignedRequest( ) builds a signed HTTPS request, sendRequest( ) transmits it in 50 ms, extractCode( ) parses the response, and verifySignature( ) checks signatures with the ‘cryptography’ library. This could be a Node.js 16.18 service on an AWS EC2 t3.medium instance, storing codes in a PostgreSQL 14 database with encrypted columns, ensuring secure code delivery over a VPN tunnel.

The Watermarking Module (406) and Communication System (400) connect to the Delivery Module (410), which manages secure transmission and release of images and attachments. Attributes include secureChannel, a string like “HTTPS/TLS,” recipientList, a collection of user IDs, and attachmentStatus, a status map (e.g., “X7K9: delivered”). Methods such as deliverPreviewImage( ) sends images via NGINX 1.20 in 200 ms, handleAttachmentRequest( ) processes recipient requests, deliverFullAttachment( ) releases files post-authentication, sendData( ) transmits over TLS, and updateImagelnNetwork( ) pushes watermark updates. This might be implemented in Java 17 on a Red Hat server with 10 Gbps bandwidth, using RabbitMQ 3.9 for asynchronous delivery to 1,000 recipients.

The Delivery Module (410) interacts with the Recipient (412), representing the end-user requesting attachments. Attributes include userCredentials, a pair like “jdoe:,” accessToken, an OAuth token, and requestID, a unique string (e.g., “REQ789”). Methods are requestFullAttachment( ), sending a POST request via a React 18 portal, and provideCredentials( ), submitting MFA data. This could be a browser-based client on Windows 11 with Chrome 123, interfacing with the system via a secure web interface, logging actions to a local SQLite database.

The Delivery Module (410) also connects to the Authentication Module (414), which verifies recipient access. Attributes include authService, a string like “Okta,” mfaStatus, a boolean, and rolePolicies, an RBAC map. Methods like authenticateUser( ) initiates verification, promptUserForCredentials( ) requests input via HTTPS, performMultiFactorAuth( ) uses SMS via Twilio, verifyCredentials( ) checks against LDAP, validateToken( ) confirms watermark codes, and verifyRole( ) ensures policy compliance. This might be an Okta-integrated Python service on a cloud instance with 8 vCPUs, completing authentication in 1 second and caching results in Redis 6.2.

The Delivery Module (410) and Communication System (400) associate with the Tracking Module (416), which monitors watermark movement. Attributes include watermarkLog, a list of detections, auditTrail, a detailed log, and domainBoundary, a regex like “.company.com.” Methods such as monitorWatermark( ) scans network traffic every 5 seconds, initializeAuditLog( ) sets up Splunk 8.2 indexing, detectImageLocation( ) identifies IPs, and logEvent( ) records to Elasticsearch. This could be a Splunk cluster with 64 GB RAM per indexer, processing 1,000 events per second, ensuring comprehensive tracking.

The Tracking Module (416) links to the Control Module (418), which enforces security actions. Attributes include dlpRules, a set of blocking patterns, endpointActions, commands like “delete,” and enforcementPolicy, a config file. Methods like enforceControls( ) triggers actions, triggerDLP( ) blocks via Symantec DLP 15.8, and remoteDelete( ) uses Intune scripts. This might be a Symantec appliance with 32 GB RAM, executing blocks in 30 ms and logging to Azure SQL, maintaining network security.

The Tracking Module (416) also connects to the SIEM System (420), enhancing monitoring with alerts. Attributes include alertRules, conditions like “watermark_outside_domain,” logDatabase, a 1 TB store, and realTimeMonitor, a polling interval. Methods such as processDetectionData( ) analyzes logs, generateAlert( ) sends emails in 2 seconds, and syncWithTracking( ) syncs via REST APIs. This could be IBM QRadar 7.4 on a four-node cluster with 128 GB RAM, integrating with Splunk for real-time oversight.

As depicted in the figure, the sample connections illustrate a robust structure: Communication System (400) associates with Processing Module (402), Delivery Module (410), and Tracking Module (416) for workflow initiation and oversight; Processing Module (402) links to Sandbox Environment (404) and Watermarking Module (406) for rendering and watermarking; Watermarking Module (406) connects to Secure Server (408) and Delivery Module (410) for code retrieval and delivery; Delivery Module (410) interacts with Recipient (412), Authentication Module (414), and Tracking Module (416) for transmission and monitoring; Recipient (412) and Authentication Module (414) associate bidirectionally for requests; Tracking Module (416) links to Control Module (418) and SIEM System (420) for enforcement and alerts; and Control Module (418) and SIEM System (420) feed back to Delivery Module (410) and Tracking Module (416), respectively. This detailed class diagram, implementable with tools like Java, Python, and enterprise software, supports a secure, traceable attachment system.

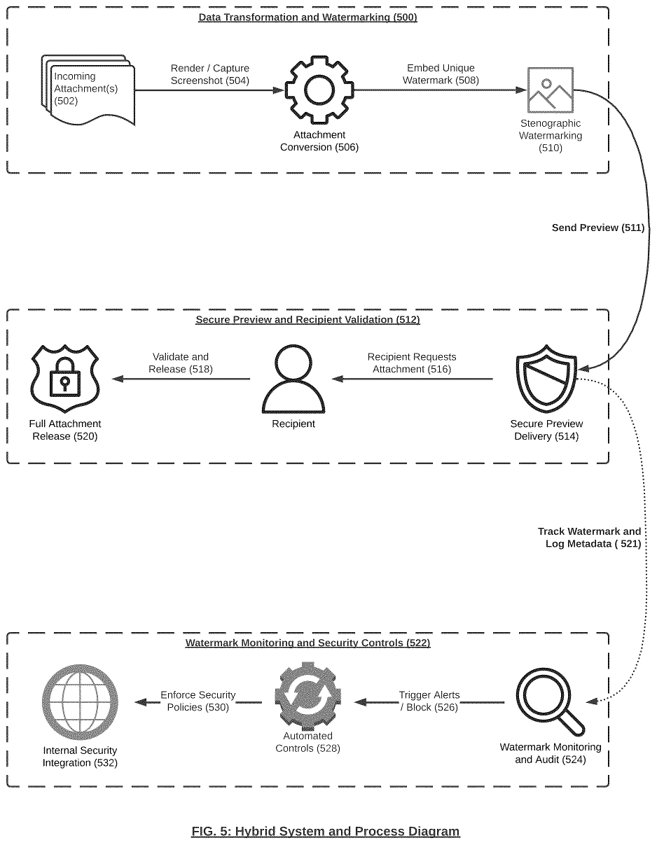

FIG. 5 offers a hybrid schematic illustration of a system and process diagram that integrates data transformation, watermarking, secure preview delivery, recipient validation, and watermark monitoring with security controls. The figure delineates a structured flow of interconnected components, each with a specific role in managing digital attachments from receipt to release. The initial section, labeled Data Transformation and Watermarking (500), comprises multiple steps that handle incoming files. This section starts with one or more Incoming Attachment(s) (502), where documents or files enter the system as the first point of interaction. These attachments then transition to Render/Capture Screenshot (504), a step where the system processes the content by rendering it into a viewable form or capturing a screenshot, preparing the material for subsequent stages. Next, Attachment Conversion (506) takes place, converting the rendered or captured attachment into a format compatible with the system's requirements, ensuring uniformity for further processing. This conversion leads to Embed Unique Watermark (508), a phase where the system embeds a distinct watermark into the attachment, marking it with a unique identifier for traceability and ownership verification. The final step within Data Transformation and Watermarking (500) is Stenographic Watermarking (510), where the system applies steganographic techniques to conceal additional data within the attachment, enhancing its security through hidden information embedding. The output of this step, Send Preview (511), connects to the next phase, underscoring the transition from watermarking to delivery.

The Send Preview (511) output from Stenographic Watermarking (510) feeds into the Secure Preview and Recipient Validation (512) section, which focuses on controlled access and validation. This section begins with Secure Preview Delivery (514), where the system transmits the watermarked preview to the intended recipient through a secure channel, ensuring protection during transfer. The recipient interacts with this preview through Recipient Requests Attachment (516), a step where they signal their need to access the full attachment, initiating a verification sequence. This request prompts Validate and Release (518), where the system checks the recipient's identity, permissions, or other criteria to confirm authorization before proceeding. Upon successful validation, Full Attachment Release (520) occurs, granting the recipient access to the complete attachment in its entirety. The components within Secure Preview and Recipient Validation (512)—Secure Preview Delivery (514), Recipient Requests Attachment (516), Validate and Release (518), and Full Attachment Release (520)—form a cohesive unit dedicated to safeguarding the attachment while facilitating legitimate access, ensuring that only verified individuals retrieve sensitive content.

FIG. 5 extends its scope with the Watermark Monitoring and Security Controls (522) section, which oversees the attachment's security post-delivery. This section starts with Watermark Monitoring and Audit (524), a process that tracks the embedded watermark and logs metadata, creating a detailed record of the attachment's usage and interactions. This monitoring connects to Secure Preview Delivery (514) through Track Watermark and Log Metadata (521), a linkage that initiates tracking at the preview stage and maintains a continuous audit trail. If the system detects unauthorized activity or policy violations, Trigger Alerts/Block (526) activates, issuing notifications to administrators or blocking access to the attachment, preventing potential breaches. Automated Controls (528) support this by enforcing predefined rules, executing security measures without human input, streamlining the response process. Enforce Security Policies (530) ensures compliance with organizational or regulatory standards, applying consistent guidelines across all operations. The section concludes with Internal Security Integration (532), which aligns the watermark monitoring and security controls with the organization's broader security infrastructure, fostering compatibility and reinforcing protection across systems.

The figure's design highlights the interplay between its three main sections: Data Transformation and Watermarking (500), Secure Preview and Recipient Validation (512), and Watermark Monitoring and Security Controls (522). The process begins with the receipt of Incoming Attachment(s) (502), progresses through rendering, conversion, and watermark embedding, and culminates in a secure preview via Send Preview (511). The recipient's journey from preview to full access hinges on validation, while monitoring and security controls maintain oversight throughout. The connection via Track Watermark and Log Metadata (521) between Secure Preview Delivery (514) and Watermark Monitoring and Audit (524) ties the sections together, ensuring that every attachment remains traceable and secure. This sample workflow reflects a system engineered for precision, security, and accountability, balancing the need for access with stringent protective measures. Each component, from the initial attachment handling to the final security integration, contributes to a robust framework capable of managing sensitive digital content across its lifecycle.

Pseudocode exemplars for implementing various aspects of this disclosure are set forth below with explanations for reference.

```
// Define global variables and constants
SET SANDBOX_ENVIRONMENT = “isolated_virtual_machine”
SET IMAGE_PROCESSING_LIBRARY = “OpenCV”
SET STEGANOGRAPHY_ALGORITHM = “LSB_insertion”
SET ALTERNATE_STEGANOGRAPHY = “Frequency_Domain_DCT”
SET WATERMARK_REFRESH_INTERVAL = 24_hours
SET AUTHENTICATION_SERVICE = “Okta”
SET NETWORK_SECURITY_PROTOCOLS = [“SAML”, “OAuth2.0”, “TLS”]
SET DLP_SYSTEM = “Symantec_DLP”
SET SIEM_SYSTEM = “Splunk”
SET ENDPOINT_MANAGEMENT = “MS_Intune”
// Function to process incoming attachment
FUNCTION processIncomingAttachment(attachment) {
  SET sandbox = initializeSandbox(SANDBOX_ENVIRONMENT)
  SET renderedContent = renderAttachmentInSandbox(attachment, sandbox)
  SET previewImage = captureScreenshot(renderedContent)
  IF attachment.isNonVisual THEN
    SET previewImage = generateMetadataImage(attachment.metadata)
  ENDIF
  CALL normalizeImage(previewImage)
  SET watermark = generateWatermark( )
  CALL embedWatermark(previewImage, watermark)
  RETURN previewImage
}
// Function to initialize sandbox environment
FUNCTION initializeSandbox(environment) {
  SET sandbox = createVirtualEnvironment(environment)
  CONFIGURE sandbox WITH securitySettings = [“no_network_access”,
“read_only_filesystem”]
  RETURN sandbox
}
// Function to render attachment in sandbox
FUNCTION renderAttachmentInSandbox(attachment, sandbox) {
  SET fileType = determineFileType(attachment)
  IF fileType IN [“pdf”, “docx”] THEN
    SET renderedContent = executeCommand(sandbox, “LibreOffice --headless --
convert-to png”, attachment)
  ELSE IF file Type IN [“html”, “webpage”] THEN
    SET renderedContent = executeCommand(sandbox, “Puppeteer --screenshot”,
attachment)
  ELSE
    SET renderedContent = attachment.rawData
  ENDIF
  RETURN renderedContent
}
// Function to generate metadata image for non-visual files
FUNCTION generateMetadataImage(metadata) {
  SET image = createBlankImage(800, 600)
  SET textContent = formatMetadata(metadata, “key: value”)
  CALL drawTextOnImage(image, textContent, position = (50, 50))
  RETURN image
}
// Function to normalize image
FUNCTION normalizeImage(image) {
  SET normalizedImage = applyFilter(image, IMAGE_PROCESSING_LIBRARY,
“color_normalization”)
  SET normalizedImage = resizeImage(normalizedImage, width = 800, height = 600)
  RETURN normalizedImage
}
// Function to generate unique watermark
FUNCTION generateWatermark( ) {
  SET characterSequence = generateRandomString(length = 16)
  SET dynamicCode = requestDynamicCodeFromServer( )
  SET watermark = combine(characterSequence, dynamicCode)
  RETURN watermark
}
// Function to request dynamic code from server
FUNCTION requestDynamicCodeFromServer( ) {
  SET connection = establishSecureConnection(“HTTPS/TLS”)
  SET request = createSignedRequest(connection, algorithm = “RSA”)
  SET response = sendRequest(connection, request)
  SET dynamicCode = extractCode(response)
  CALL verifySignature(response, “RSA”)
  RETURN dynamicCode
}
// Function to embed watermark into image
FUNCTION embedWatermark(image, watermark) {
  IF STEGANOGRAPHY_ALGORITHM = “LSB_insertion” THEN
    SET modifiedImage = applyLSBInsertion(image, watermark)
  ELSE IF STEGANOGRAPHY_ALGORITHM = “Frequency_Domain_DCT” THEN
    SET modifiedImage = applyDCTTransform(image, watermark)
  ENDIF
  RETURN modifiedImage
}
// Function to apply LSB insertion for watermarking
FUNCTION applyLSBInsertion(image, watermark) {
  SET pixelArray = convertImageToPixelArray(image)
  SET bitStream = convertWatermarkToBits(watermark)
  FOR EACH pixel IN pixelArray DO
    SET leastSignificantBit = bitStream.nextBit( )
    MODIFY pixel TO SET leastSignificantBit
  END FOR
  SET watermarkedImage = convertPixelArrayToImage(pixelArray)
  RETURN watermarkedImage
}
// Function to apply DCT transform for watermarking
FUNCTION applyDCTTransform(image, watermark) {
  SET frequencyCoefficients = performDCT(image)
  SET bitStream = convertWatermarkToBits(watermark)
  FOR EACH coefficient IN frequencyCoefficients DO
    IF coefficient.isMidFrequency THEN
      MODIFY coefficient WITH bitStream.nextBit( )
    ENDIF
  END FOR
  SET watermarkedImage = performInverseDCT(frequencyCoefficients)
  RETURN watermarkedImage
}
// Function to deliver preview image
FUNCTION deliverPreviewImage(previewImage, recipient) {
  SET secureChannel = establishSecureChannel(“HTTPS/TLS”)
  CALL sendData(secureChannel, previewImage, recipient)
}
// Function to handle full attachment request
FUNCTION handleAttachmentRequest(previewImage, recipient) {
  SET authResult = authenticateUser(recipient, AUTHENTICATION_SERVICE)
  IF authResult.success THEN
    SET roleCheck = verifyRole(recipient, “RBAC_policy”)
    SET tokenCheck = validateToken(previewImage.watermark.dynamicCode)
    IF roleCheck AND tokenCheck THEN
      SET fullAttachment = retrieveOriginalAttachment(previewImage)
      CALL deliverFullAttachment(fullAttachment, recipient)
    ENDIF
  ENDIF
}
// Function to authenticate user
FUNCTION authenticateUser(recipient, service) {
  SET credentials = promptUserForCredentials(recipient)
  SET mfaResult = performMultiFactorAuth(service, recipient)
  SET authResult = verifyCredentials(service, credentials, mfaResult)
  RETURN authResult
}
// Function to deliver full attachment
FUNCTION deliverFullAttachment(attachment, recipient) {
  SET secureChannel = establishSecureChannel(“HTTPS/TLS”)
  CALL sendData(secureChannel, attachment, recipient)
}
// Function to monitor watermark and enforce controls
FUNCTION monitorWatermark(previewImage) {
  SET auditLog = initializeAuditLog(SIEM_SYSTEM)
  WHILE previewImage.existsInNetwork DO
    SET location = detectImageLocation(previewImage)
    CALL logEvent(auditLog, location, timestamp = currentTime( ))
    IF location.outsideSecureDomain THEN
      CALL enforceControls(previewImage, location)
    ENDIF
  END WHILE
}
// Function to enforce controls on unauthorized transmission
FUNCTION enforceControls(previewImage, location) {
  SET dlpAction = triggerDLP(DLP_SYSTEM, “block_transmission”)
  IF dlpAction.failed THEN
    CALL remoteDelete(ENDPOINT_MANAGEMENT, previewImage, location)
  ENDIF
}
// Function to refresh watermark periodically
FUNCTION refreshWatermark(previewImage) {
  SET intervalTimer = setTimer(WATERMARK_REFRESH_INTERVAL)
  WHEN intervalTimer.expires DO
    SET newWatermark = generateWatermark( )
    SET updatedImage = embedWatermark(previewImage, newWatermark)
    CALL updateImagelnNetwork(updatedImage)
  END WHEN
}
// Main execution flow
FUNCTION main(attachment, recipient) {
  SET previewImage = processIncomingAttachment(attachment)
  CALL deliverPreviewImage(previewImage, recipient)
  CALL monitorWatermark(previewImage)
  IF recipient.requestsFullAttachment THEN
    CALL handleAttachmentRequest(previewImage, recipient)
  ENDIF
  CALL refreshWatermark(previewImage)
}
```

The pseudocode provided outlines a sample implementation of a system designed to secure electronic attachments through a multi-step process. The initial segment defines global variables and constants that establish the foundational components, such as the sandbox environment set to an isolated virtual machine, image processing library designated as OpenCV, and steganography algorithms including Least Significant Bit insertion and Frequency Domain Discrete Cosine Transform. Additional constants specify the watermark refresh interval as 24 hours, authentication service as Okta, network security protocols including SAML, OAuth 2.0, and TLS, and systems for data loss prevention, security information and event management, and endpoint management, ensuring all necessary tools are preconfigured for the system's operation.

The processIncomingAttachment function serves as the entry point for handling attachments, initiating the transformation process by setting up a sandbox environment where the attachment is rendered safely. Depending on the attachment's nature, it either captures a screenshot of visual content or generates a metadata-based image for non-visual files, followed by normalization and watermark embedding. The initializeSandbox function configures a virtual environment with strict security settings, such as no network access and a read-only filesystem, to prevent any unintended execution of malicious content during rendering.

Rendering within the sandbox, as detailed in renderAttachmentInSandbox, adapts to file types by using appropriate tools like LibreOffice for documents or Puppeteer for web content, ensuring accurate visual capture. For non-visual files, generateMetadataImage constructs an image from metadata, drawing text onto a blank canvas to provide a meaningful preview. The normalizeImage function then standardizes the image's appearance using OpenCV, adjusting size and color to create a uniform output suitable for further processing.

Watermark generation, handled by generateWatermark, combines a random character sequence with a dynamic code fetched securely from a server via requestDynamicCodeFromServer. This function establishes an HTTPS/TLS connection, sends a signed request using RSA, and verifies the response's signature, ensuring the code's integrity. The embedWatermark function applies the chosen steganography method, with applyLSBInsertion modifying pixel bits subtly or applyDCTTransform altering frequency coefficients, embedding the watermark in a way that balances invisibility and durability.

The delivery of the preview image to the recipient, managed by deliverPreviewImage, occurs over a secure HTTPS/TLS channel, ensuring safe transmission without executable content. When a recipient requests the full attachment, handleAttachmentRequest orchestrates authentication through authenticateUser, which integrates with Okta for credential verification and multi-factor authentication, followed by role and token validation before releasing the attachment via deliverFullAttachment over a secure channel.

Monitoring and control mechanisms, implemented in monitorWatermark, track the preview image's movement using a SIEM system like Splunk, logging each location and timestamp. If the image exits the secure domain, enforceControls triggers Data Loss Prevention actions to block transmission or remotely delete the image using endpoint management tools like MS Intune. The refreshWatermark function ensures ongoing security by periodically updating the watermark, re-embedding a new version into the image and distributing it across the network.

The main function ties these components together, processing the attachment, delivering the preview, monitoring its distribution, handling full attachment requests, and refreshing watermarks as needed, providing a cohesive execution flow. Each function encapsulates a specific aspect of the system, from sandboxed rendering to dynamic watermarking, authentication, and network enforcement, reflecting the invention's comprehensive approach to securing electronic communications.

The various sample systems and methods described herein offer a variety of alternatives, modifications, combinations, and customizations that can be implemented while remaining within the spirit and scope of the disclosure. One potential alternative involves the choice of sandbox environment for rendering attachments. Instead of relying on an isolated virtual machine, the system could utilize containerization technologies such as Docker or Kubernetes, which provide lightweight, isolated environments with similar security benefits. This modification would maintain the core principle of safe rendering by ensuring that attachments are processed without risking the host system, adapting the approach to different computational resources or operational preferences.

Another customization could pertain to the tools used for rendering attachments within the sandbox. While LibreOffice in headless mode and Puppeteer are specified for documents and web content respectively, alternative software like Apache PDFBox for PDFs or Selenium for web rendering could be employed. These substitutes would still achieve the goal of generating a visual representation of the attachment, allowing the system to produce preview images without altering the underlying security framework. Such flexibility ensures compatibility with diverse file types and organizational toolsets.

The image processing library presents additional opportunities for variation. Although OpenCV is designated for normalization, other libraries like PIL (Python Imaging Library) or ImageMagick could be integrated to standardize image appearance. These alternatives would preserve the objective of creating uniform preview images suitable for watermarking, offering options based on performance needs or existing infrastructure. The normalization process itself could be adjusted, such as changing the target resolution from 800×600 to a higher or lower value, tailoring the output to specific display requirements without deviating from the system's intent.

In the realm of steganographic watermarking, the disclosure allows for multiple algorithmic approaches beyond the specified Least Significant Bit insertion and Frequency Domain Discrete Cosine Transform. Techniques such as Discrete Wavelet Transform or spread spectrum steganography could be adopted, each embedding the watermark in a manner that ensures traceability and authenticity. These methods would align with the goal of concealing unique identifiers within the image, providing robustness against different forms of image manipulation or compression, thus broadening the system's applicability.

The frequency of watermark refresh offers a point of customization. While a 24-hour interval is set, this could be modified to shorter periods like 12 hours or longer intervals such as 48 hours, depending on security needs or operational tempo. The refresh mechanism could also incorporate event-based triggers, such as user requests or detected anomalies, rather than a fixed schedule, maintaining the dynamic nature of the watermark while adapting to real-time conditions. This flexibility ensures the system remains responsive to varying threat landscapes. The schedule may also be random or randomized.

Authentication services provide another area for modification. Instead of Okta, alternatives like Auth0, Microsoft Entra ID, or even a custom-built identity management solution could be integrated. The authentication process could be expanded to include biometric verification or single sign-on protocols, enhancing security without altering the core requirement of verifying recipient identity before releasing full attachments. Such adaptations would uphold the principle of controlled access within different organizational ecosystems.

Network security protocols also permit variation. Beyond SAML, OAuth 2.0, and TLS, additional standards like OpenID Connect or Kerberos could be incorporated to secure data transmission and API interactions. The secure APIs themselves, built on platforms like Apigee or Mulesoft, could be replaced with other frameworks such as AWS API Gateway or custom RESTful implementations, preserving the goal of enforcing restrictions on image distribution. These options ensure compatibility with diverse network architectures.

The tools for monitoring and enforcement, such as Splunk for SIEM and Symantec for DLP, can be substituted with alternatives like IBM QRadar or Microsoft Endpoint DLP, respectively. Endpoint management could shift from MS Intune to solutions like VMware Workspace ONE, maintaining the ability to track and control watermarked images across devices. These substitutions would still support real-time monitoring and automated responses, aligning with the system's traceability and security objectives.

Combinations of these elements are also feasible. For instance, the system could pair containerized sandboxing with ImageMagick for normalization and Discrete Wavelet Transform for watermarking, creating a tailored configuration that optimizes resource use and watermark resilience. Another combination might integrate Selenium for rendering, Auth0 for authentication, and OpenID Connect for network security, crafting a setup suited to web-heavy environments. These combinations illustrate how components can be mixed to address specific use cases while adhering to the disclosure's principles.

Customization extends to the metadata image generation for non-visual files. The system could alter the layout, font, or content of the metadata display, such as including additional fields like file hash or creation date, enhancing the preview's utility. The size of the blank image canvas could be adjusted from 800×600 to other dimensions, ensuring readability on different screens, all while retaining the purpose of providing a safe, informative representation.

The delivery mechanism for preview images and full attachments could be modified to use alternative secure channels, such as SFTP or proprietary encrypted protocols, instead of HTTPS/TLS. This change would maintain data protection during transit, offering flexibility for organizations with unique communication infrastructures. The audit logging process could also be customized to include additional metadata, like user IDs or device identifiers, enriching the traceability feature without departing from its intent.

Integration with existing systems allows further adaptation. The system could interface with different enterprise security frameworks, such as firewalls or intrusion prevention systems beyond those specified, using custom APIs or protocols. This integration would ensure seamless operation within varied IT environments, preserving the goal of enhancing overall network security through watermark tracking and control.

The sandbox rendering process could be modified to include pre-scanning steps, such as virus checks using tools like ClamAV before generating the preview, adding an extra layer of safety. Alternatively, the rendering could be parallelized across multiple sandbox instances to handle high volumes of attachments, improving efficiency while maintaining isolation. These enhancements would align with the system's focus on secure processing.

Watermark embedding could be customized to adjust the depth or placement of data within the image. For example, embedding could target specific regions of the image rather than the entire surface, or vary the bit depth used in LSB insertion, balancing visibility and capacity. Such adjustments would still enable tracking and verification, offering fine-tuned control over the steganographic process.

The enforcement actions triggered by unauthorized transmission could be expanded. Beyond blocking or deleting, the system could quarantine the image, notify administrators, or initiate a forensic analysis, providing a spectrum of responses tailored to security policies. This range of options ensures the system remains proactive in protecting data integrity.

Combinations across these modifications are envisioned, such as pairing a custom authentication solution with SFTP delivery and enhanced audit logging, creating a highly specialized implementation. Another might combine parallel sandboxing with alternative DLP tools and event-based watermark refreshes, optimizing for scale and responsiveness. These permutations demonstrate the system's adaptability to diverse requirements.

While the present technology has been explained through what are currently regarded as the most practical and preferred embodiments, it should be recognized that these specifics are provided solely for illustrative purposes, and the disclosure is not confined to the particular descriptions and embodiments outlined. Instead, it is intended to encompass modifications and comparable arrangements that fall within the spirit and scope of the appended claims. For instance, it is understood that the present technology envisions the possibility of integrating, where feasible, one or more elements from any given embodiment with one or more elements from any other embodiment. This approach ensures that the disclosure remains broad and flexible, accommodating a wide array of implementations that uphold its core objectives of securing and tracking electronic attachments.

1. A method for securing electronic attachments in a communication system, comprising:
receiving, by a processing module, an electronic attachment transmitted through the communication system, wherein the electronic attachment includes digital content;
rendering, by the processing module, the electronic attachment within a sandbox environment to generate a preview image, wherein the sandbox environment is configured to isolate the electronic attachment from the communication system and prevent execution of the digital content;
embedding, by a watermarking module, a steganographic watermark into the preview image, wherein the steganographic watermark includes a unique identifier and a dynamic code configured to be periodically updated;
transmitting, by a delivery module, the preview image with the embedded steganographic watermark to a recipient over a secure channel, wherein the secure channel employs a transport layer security protocol;
authenticating, by an authentication module, a request from the recipient for the electronic attachment, wherein the authentication module verifies the recipient's credentials and the dynamic code within the steganographic watermark;
releasing, by the delivery module, the electronic attachment to the recipient over the secure channel upon successful authentication; and
monitoring, by a tracking module, the preview image within the communication system using the steganographic watermark to detect movement of the preview image outside a designated secure domain.

2. The method of claim 1, wherein the sandbox environment is configured as a virtual machine with restricted network access and a read-only filesystem.

3. The method of claim 2, further comprising:
normalizing, by the processing module, the preview image to standardize color and resolution prior to embedding the steganographic watermark; and
generating, by the processing module, the preview image with metadata text when the electronic attachment lacks visual content.

4. The method of claim 3, wherein the steganographic watermark is embedded using a least significant bit insertion technique modifying pixel values of the preview image.

5. The method of claim 4, further comprising:
refreshing, by the watermarking module, the dynamic code within the steganographic watermark at a predetermined interval; and
updating, by the delivery module, the preview image with the refreshed dynamic code across the communication system.

6. The method of claim 5, wherein the authentication module employs a multi-factor authentication process to verify the recipient's credentials, including a secure token associated with the request.

7. The method of claim 6, further comprising:
logging, by the tracking module, each detected instance of the preview image within the communication system using the unique identifier; and
associating, by the tracking module, transmission metadata with each logged instance.

8. The method of claim 7, further comprising:
enforcing, by a control module, a restriction on the preview image by blocking transmission outside the designated secure domain upon detection by the tracking module; and
initiating, by the control module, a remote deletion of the preview image from an endpoint outside the designated secure domain when blocking is unsuccessful.

9. The method of claim 8, wherein the processing module renders the electronic attachment using a headless application selected based on a file type of the electronic attachment.

10. The method of claim 9, wherein the watermarking module requests the dynamic code from a secure server over a connection secured by a transport layer security protocol, and verifies a digital signature of the dynamic code using an asymmetric encryption algorithm.

11. A method for securing electronic attachments in a communication system, comprising:
receiving, by a processing module, an electronic attachment transmitted through the communication system, wherein the electronic attachment includes digital content potentially containing executable elements;
rendering, by the processing module, the electronic attachment within a sandbox environment to generate a preview image, wherein the sandbox environment is configured as a virtual machine with restricted network access and a read-only filesystem to isolate the electronic attachment from the communication system and prevent execution of the digital content;
normalizing, by the processing module, the preview image to standardize color and resolution, and generating the preview image with metadata text when the electronic attachment lacks visual content;
embedding, by a watermarking module, a steganographic watermark into the preview image using a least significant bit insertion technique modifying pixel values of the preview image, wherein the steganographic watermark includes a unique identifier and a dynamic code configured to be periodically updated;
requesting, by the watermarking module, the dynamic code from a secure server over a connection secured by a transport layer security protocol, and verifying a digital signature of the dynamic code using an asymmetric encryption algorithm;
transmitting, by a delivery module, the preview image with the embedded steganographic watermark to a recipient over a secure channel, wherein the secure channel employs the transport layer security protocol;
authenticating, by an authentication module, a request from the recipient for the electronic attachment, wherein the authentication module verifies the recipient's credentials using a multi-factor authentication process including a secure token associated with the request, and confirms the dynamic code within the steganographic watermark;
releasing, by the delivery module, the electronic attachment to the recipient over the secure channel upon successful authentication;
monitoring, by a tracking module, the preview image within the communication system using the steganographic watermark to detect movement of the preview image outside a designated secure domain;
logging, by the tracking module, each detected instance of the preview image within the communication system using the unique identifier, and associating transmission metadata with each logged instance;
enforcing, by a control module, a restriction on the preview image by blocking transmission outside the designated secure domain upon detection by the tracking module, and initiating a remote deletion of the preview image from an endpoint outside the designated secure domain when blocking is unsuccessful;
refreshing, by the watermarking module, the dynamic code within the steganographic watermark at a predetermined interval, and updating, by the delivery module, the preview image with the refreshed dynamic code across the communication system;
rendering, by the processing module, the electronic attachment using a headless application selected based on a file type of the electronic attachment;
integrating, by an interface module, the communication system with a security information and event management system to provide real-time alerts upon detection of the preview image outside the designated secure domain; and
adjusting, by the control module, enforcement actions based on a predefined policy specifying conditions for blocking, deleting, or quarantining the preview image.

12. A system for securing electronic attachments in a communication network, comprising:
a processing module configured to receive an electronic attachment transmitted through the communication network, wherein the electronic attachment includes digital content, and to render the electronic attachment within a sandbox environment to generate a preview image, wherein the sandbox environment isolates the electronic attachment from the communication network and prevents execution of the digital content;
a watermarking module configured to embed a steganographic watermark into the preview image, wherein the steganographic watermark includes a unique identifier and a dynamic code configured to be periodically updated;
a delivery module configured to transmit the preview image with the embedded steganographic watermark to a recipient over a secure channel, wherein the secure channel employs a transport layer security protocol, and to release the electronic attachment to the recipient over the secure channel upon successful authentication;
an authentication module configured to authenticate a request from the recipient for the electronic attachment by verifying the recipient's credentials and the dynamic code within the steganographic watermark; and
a tracking module configured to monitor the preview image within the communication network using the steganographic watermark to detect movement of the preview image outside a designated secure domain.

13. The system of claim 12, wherein the sandbox environment of the processing module is configured as a virtual machine with restricted network access and a read-only filesystem.

14. The system of claim 13, wherein the processing module is further configured to normalize the preview image to standardize color and resolution before the steganographic watermark is embedded, and to generate the preview image with metadata text when the electronic attachment lacks visual content.

15. The system of claim 14, wherein the watermarking module is configured to embed the steganographic watermark using a least significant bit insertion technique modifying pixel values of the preview image.

16. The system of claim 15, wherein the watermarking module is further configured to refresh the dynamic code within the steganographic watermark at a predetermined interval, and the delivery module is further configured to update the preview image with the refreshed dynamic code across the communication network.

17. The system of claim 16, wherein the authentication module is configured to employ a multi-factor authentication process to verify the recipient's credentials, including validation of a secure token associated with the request.

18. The system of claim 17, wherein the tracking module is further configured to log each detected instance of the preview image within the communication network using the unique identifier and to associate transmission metadata with each logged instance.

19. The system of claim 18, further comprising:
a control module configured to enforce a restriction on the preview image by blocking transmission outside the designated secure domain upon detection by the tracking module, and to initiate a remote deletion of the preview image from an endpoint outside the designated secure domain when blocking is unsuccessful.

20. The system of claim 19, wherein:
the processing module is further configured to render the electronic attachment using a headless application selected based on a file type of the electronic attachment, wherein the headless application operates within the sandbox environment to produce the preview image;
the watermarking module is further configured to request the dynamic code from a secure server over a connection secured by the transport layer security protocol, to verify a digital signature of the dynamic code using an asymmetric encryption algorithm, and to adjust an embedding depth of the steganographic watermark based on a security level assigned to the electronic attachment;
the delivery module is further configured to encrypt the preview image prior to transmission using a symmetric encryption key derived from the secure channel, and to maintain a record of each transmission of the preview image and the electronic attachment;
the authentication module is further configured to integrate with an identity management service to retrieve the recipient's credentials, to cross-reference the recipient's role against a predefined access policy, and to re-authenticate the recipient if the dynamic code has been refreshed since the request was initiated;
the tracking module is further configured to interface with a security information and event management system to log real-time movement data of the preview image, and to generate an audit trail linking the unique identifier to each logged instance; and
the control module is further configured to adjust enforcement actions based on a predefined policy specifying conditions for blocking, deleting, or quarantining the preview image, and to notify an administrator via the security information and event management system when the preview image is detected outside the designated secure domain.
